(19) United States
(12) Patent Application Publication
(10) Pub. No.: US 2026/0095297 A1
(43) Pub. Date: Apr. 2, 2026

(54) INTERFERENCE MANAGEMENT

(71) Applicant: Lenovo (Singapore) Pte. Limited, Singapore (SG)

(72) Inventors: Majid Ghanbarinejad, Lake Forest, CA (US); Vijay Nangia, Woodridge, IL (US); Khaled Nafez Rauf Ardah, Ilmenau (DE); Hossein Bagheri, Urbana, IL (US); Hyejung Jung, Northbrook, IL (US)

(73) Assignee: Lenovo (Singapore) Pte. Limited, Singapore (SG)

(21) Appl. No.: 19/112,546

(22) PCT Filed: Sep. 28, 2023
(86) PCT No.: PCT/IB2023/059709

§ 371 Date: Mar. 17, 2025

Related U.S. Application Data
(60) Provisional application No. 63/410,969, filed on Sep. 28, 2022.

(51) Int. Cl. H04L 5/14

(52) U.S. Cl. CPC H04L 5/14

(57) ABSTRACT

Various aspects of the present disclosure relate to methods, apparatuses, and systems that support interference management. For instance, implementations provide for clustering of base stations (e.g., gNBs) in association with resources, such as time slots. Further, base stations can be pre-configured by a network function and/or perform signaling (e.g., with the core network and/or other base stations) to form new clusters, negotiate resources (e.g., slots) associated with a new cluster, join existing clusters, and so on.

### RELATED APPLICATION

This application claims priority to U.S. Provisional Application Ser. No. 63/410,969 filed 28 Sep. 2022 entitled “INTERFERENCE MANAGEMENT,” the disclosure of which is incorporated by reference herein in its entirety.

### TECHNICAL FIELD

The present disclosure relates to wireless communications, and more specifically to interference management.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for interference management such as part of implementing time division duplex (TDD) operation. However, such systems may fail to account for scenarios where base stations in a vicinity configure non-matching TDD patterns, and interference from one base station to another may occur, hence degrading performance.

### SUMMARY

The present disclosure relates to methods, apparatuses, and systems that support interference management. For instance, implementations provide for clustering of gNBs in association with resources, such as time slots. The gNBs can communicate with a subset of served UEs with appropriate beamforming while avoiding inter-gNB Cross-Link Interference (CLI) from other gNBs. On other time slots, gNBs can be grouped into different clusters, hence allowing them to communicate with another subset of served UEs with a different beamforming. Further, gNBs can be pre-configured by a network function (e.g., operation, administration, and maintenance (OAM)) and/or perform signaling (e.g., with the core network and/or other gNBs) to form new clusters, negotiate resources (e.g., slots) associated with a new cluster, join existing clusters, and so on.

Thus, the described techniques for efficient utilization of available wireless resources while reducing interference between network entities (e.g., gNBs) using the available wireless resources.

Some implementations of the methods and apparatuses described herein may further include obtaining, by a first apparatus, a first configuration associating the first apparatus to a group and a plurality of resources; obtaining a second configuration of a time-division duplexing (TDD) assignment for the group on the plurality of resources; and applying the TDD assignment for performing communications on the plurality of resources.

Some implementations of the methods and apparatuses described herein may further include: where obtaining the first configuration includes determining the first configuration from an OAM configuration; where obtaining the first configuration includes receiving a grouping configuration from a core network function on a backhaul interface; where obtaining the first configuration includes receiving a grouping configuration from a second base station on a backhaul interface; where the second base station includes a central coordinator of the group; where the group includes a cluster of a plurality of base stations; where the cluster is generated based on an interference level among the plurality of base stations; where the cluster is generated based on the interference level measured above a threshold; where the plurality of resources includes one or more of a plurality of slots, a plurality of orthogonal frequency-division multiplexing (OFDM) symbols, or a plurality of physical resource blocks (PRBs); where the second configuration assigns a value of one or more of downlink, uplink, or flexible to each resource in the plurality of resources; where obtaining the second configuration includes determining the second configuration from an OAM configuration.

Some implementations of the methods and apparatuses described herein may further include: where obtaining the second configuration includes receiving the second configuration from a core network function on a backhaul interface; where the first apparatus includes a first base station, and where obtaining the second configuration includes receiving the second configuration from a second base station on a backhaul interface; where the second base station includes a central coordinator of the group; further including not applying an uplink assignment indicated by the second configuration to a subset of the plurality of resources based at least in part on determining that the subset of the plurality of resources is allocated to a configured downlink signal; where the configured downlink signal includes one or more of a synchronization signal block (SSB), a physical broadcast channel, a periodic channel state information reference signal (CSI-RS), a physical downlink control channel, or a semi-persistent scheduling (SPS).

Some implementations of the methods and apparatuses described herein may further include: further including not applying a downlink assignment indicated by the second configuration to a subset of the plurality of resources based at least in part on a determination that the subset of the plurality of resources is allocated to a configured uplink signal; where the configured uplink signal includes one or more of a physical random-access channel (PRACH), a physical uplink control channel (PUCCH), or a configured grant physical uplink shared channel (CG-PUSCH); where applying the TDD assignment includes causing the first apparatus to apply one or more downlink assignments and one or more uplink assignments according to the TDD assignment; where the group is created using request-response signaling; further including implementing at least a portion of the request-response signaling, including: sending, to a second apparatus, a TDD cluster request message, the TDD cluster request message including one or more of an indication of a request to create the group, a cluster identifier, or an association with the plurality of resources; and receiving, from the second apparatus, a TDD cluster response, the TDD cluster response including an indication that the second apparatus accepts the TDD cluster request.

Some implementations of the methods and apparatuses described herein may further include: where the first apparatus includes a first base station, and the first base station includes a central coordinator; further including detecting a threshold amount of interference from the second apparatus and in response, triggering the request-response signaling; further including: receiving an interference report from a first user equipment (UE), the interference report indicating a threshold amount of interference from a second UE served by the second apparatus; and triggering the request-response signaling based at least in part on the interference report; further including implementing at least a portion of the request-response signaling, including: receiving a TDD cluster request message from a second apparatus, the TDD cluster request message including one or more of an indication of a request to create the group, a cluster identifier, or an association with the plurality of resources; determining whether to accept the TDD cluster request; and sending, based at least in part on a determination to accept the request, a TDD cluster response to the second apparatus, the TDD cluster response including an indication that the first apparatus accepts the request; where the second apparatus includes a central coordinator; where the second configuration includes an intended TDD downlink-uplink configuration information element (IE).

Some implementations of the methods and apparatuses described herein may further include generating, by a first apparatus, a configuration of a time-division duplexing (TDD) assignment for a group on a plurality of resources; and transmitting the configuration to a second apparatus.

Some implementations of the methods and apparatuses described herein may further include: where the first apparatus includes a first base station, the second apparatus includes a second base station, and the first base station includes a central coordinator of the group; further including transmitting the configuration to the second apparatus over a backhaul interface.

Some implementations of the methods and apparatuses described herein may further include implementing, by a first apparatus, at least a portion of request-response signaling to create a group, including: receiving, from a second apparatus, a Time Division Duplex (TDD) cluster request message, the TDD cluster request message including one or more of an indication of a request to create a group, a cluster identifier, or an association with a plurality of resources; and transmitting, to the second apparatus, a TDD cluster response, the TDD cluster response including an indication that the first apparatus accepts the TDD cluster request.

Some implementations of the methods and apparatuses described herein may further include: where the first apparatus includes a first base station, and the first base station includes a central coordinator; further including detecting a threshold amount of interference from the second apparatus and in response, triggering the request-response signaling; further including: receiving an interference report from a first user equipment (UE), the interference report indicating a threshold amount of interference from a second UE served by the second apparatus; and triggering the request-response signaling based at least in part on the interference report.

Some implementations of the methods and apparatuses described herein may further include transmitting, from a first apparatus to a second apparatus, a Time Division Duplex (TDD) cluster request message, the TDD cluster request message including one or more of an indication of a request to create a group, a cluster identifier, or an association with a plurality of resources; and receiving, from the second apparatus, a TDD cluster response, the TDD cluster response including an indication that the second apparatus accepts the TDD cluster request.

Some implementations of the methods and apparatuses described herein may further include: where the first apparatus includes a first base station, the second apparatus includes a second base station, and the first apparatus includes a central coordinator.

### BRIEF DESCRIPTION OF THE DRAWINGS

FIG. 1 illustrates an example of a wireless communications system that supports interference management in accordance with aspects of the present disclosure.

FIG. 2 illustrates a procedure for uplink RIM information transfer.

FIG. 3 illustrates a system for downlink RIM information transfer.

FIGS. 4a, 4b, and 4c illustrate different examples of IEs for RIM information transfer.

FIG. 5 illustrates a scenario 500 for cell clustering.

FIG. 6 illustrates a system that supports interference management in accordance with aspects of the present disclosure.

FIG. 7 illustrates a scenario for slot-based clustering that supports interference management in accordance with aspects of the present disclosure.

FIG. 8 illustrates a scenario for slot-based clustering that supports interference management in accordance with aspects of the present disclosure.

FIGS. 9-13 illustrate examples IEs that support interference management in accordance with aspects of the present disclosure.

FIG. 14 illustrates an example of a block diagram of devices that support interference management in accordance with aspects of the present disclosure.

FIGS. 15 through 21 illustrate flowcharts of methods that support interference management in accordance with aspects of the present disclosure.

### DETAILED DESCRIPTION

In wireless communications systems, time division duplexing (TDD) refers to the scheme of splitting radio resources among downlinks and uplinks in the time domain. In a TDD system, at a point in time in a given frequency, a base station can transmit signals to one or more subscriber devices or vice versa, but normally not both. In conventional cellular systems that employ static TDD, patterns of TDD are fully synchronized and typically identical so as to avoid interference from one base station (e.g., when transmitting in a downlink) to another base station (e.g., when receiving in an uplink) of a nearby cell. However, if dynamic TDD is employed, where different TDD patterns may be used in different cells, the interference from one base station to another may occur, hence degrading performance if not addressed by proper inter-base-station interference management techniques.

Furthermore, with beamforming at millimeter-wave frequencies, interference caused by a base station on another base station may be significant depending on the beamforming configurations at an interfering base station and an interfered base station. For example, if the interfering base station transmits a downlink signal with a transmit (Tx) beam that is spatially directed toward the interfered base station, and the interfered base station happens to receive an uplink signal on the same time-frequency resources with a receive (Rx) beam spatially directed toward the interfering base station, the downlink signal may cause an excessive interference on the uplink signal.

Accordingly, this disclosure provides for techniques that support interference management. For instance, implementations provide inter-base-station CLI management that enables inter-base station interference to be mitigated using the disclosed signaling and coordination among base stations. The proposed implementations may be further applied to management of other types of interference such as inter-user-equipment cross-link interference, inter-cell interference among base stations and user equipment, and the like.

For instance, implementations provide that gNBs and/or cells are grouped in clusters, and TDD configurations are matched among gNBs and/or cells in each cluster, e.g., downlink/uplink (DL/UL) directions are matched among gNBs and/or cells in a cluster. In implementations, each cluster can be identified by a cluster identifier (ID), is optionally associated with a frequency band or carrier, is associated with a plurality of time resources and/or frequency resources, and can include a plurality of gNB and/or cell IDs. Further, implementations provide signaling for resource-based clustering. For instance, a cluster can be formed statically (e.g., pre-configured by the OAM), semi-statically (e.g., indicated by signaling from the core network), dynamically and centralized (e.g., indicated by signaling from a predetermined gNB and/or cell (e.g., cluster head)), and/or dynamically and distributed, e.g., determined via signaling among gNBs and/or cells.

Accordingly, implementations provide resource-based gNB and/or cell clustering where clusters are applied to a certain set of resources (slots, sub-bands, etc.), e.g., not an entire bandwidth over periods of tie. In this way, a gNB may be a member of a first cluster at one time and a member of a second cluster at another time. This allows the gNB to match its TDD DL/UL configuration with a first set of gNBs at one time, hence serving a first set of UEs in one direction without concern for excessive interference in a first direction, and then match its TDD DL/UL configuration with a second set of gNBs at another time, hence serving a second set of UEs in a second direction, again without concern for excessive interference. Similarly, a gNB may be a member of a first cluster at one frequency and a member of a second cluster at another frequency.

Thus, the described techniques for efficient utilization of available wireless resources while reducing interference between network entities (e.g., gNBs) using the available wireless resources.

Aspects of the present disclosure are described in the context of a wireless communications system. Aspects of the present disclosure are further illustrated and described with reference to device diagrams and flowcharts.

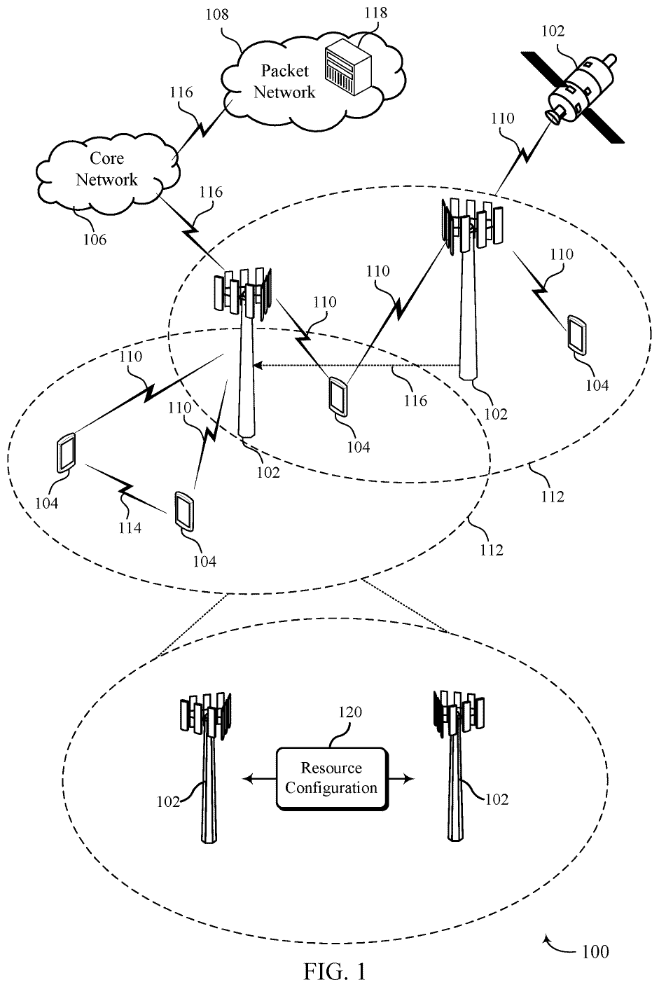

FIG. 1 illustrates an example of a wireless communications system 100 that supports interference management in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a RAN, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, MAC layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a PDU session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for interference management, network entities 102 can communicate to engage in resource configuration 120. As part of the resource configuration 120, for instance, the network entities 102 can obtain configuration associating the network entities to groups and wireless resources, can obtain configuration of TDD assignment for groups on the wireless resources. Accordingly, based at least in part on the resource configuration 120, the network entities 102 can configure resource usage, such as by applying TDD assignment for performing communications on the wireless resources.

In wireless communications systems, the atmospheric ducting phenomenon, caused by lower densities at higher altitudes in the Earth's atmosphere, causes a reduced refractive index, causing the signals to bend back towards the Earth. A signal trapped in the atmospheric duct can reach distances far greater than normal. In TDD networks with the same UL/DL slot configuration, and in the absence of atmospheric ducting, a guard period is used to avoid the interference between UL and DL transmissions in different cells. However, when the atmospheric ducting phenomenon happens, radio signals can travel a relatively long distance, and the propagation delay exceeds the guard period. Consequently, the DL signals of an aggressor cell can interfere with the UL signals of a victim cell that is far away from the aggressor. Such interference is termed as remote interference. The further the aggressor is to the victim, the more UL symbols of the victim will be impacted.

A remote interference scenario may involve a number of victim and aggressor cells, where the gNBs execute Remote Interference Management (RIM) coordination on behalf of their respective cells. Aggressor and victim gNBs can be grouped into semi-static sets, where each cell is assigned a set ID, and is configured with a RIM Reference Signal (RIM-RS) and the radio resources associated with the set ID. Each aggressor gNB can be configured with multiple set IDs and each victim gNB can be configured with multiple set IDs, whereas each cell can have at most one victim set ID and one aggressor set ID. Consequently, each gNB can be an aggressor and a victim at the same time.

To mitigate remote interference, the network enables RIM frameworks for coordination between victim and aggressor gNBs. The coordination communication in RIM frameworks can be wireless- or backhaul-based. The backhaul-based RIM framework uses a combination of wireless and backhaul communication, while in the wireless framework, the communication is purely wireless.

In both frameworks, all gNBs in a victim set simultaneously transmit an identical RIM reference signal carrying the victim set ID over the air.

In the wireless framework, upon reception of the RIM reference signal from the victim set, aggressor gNBs undertake RIM measures, and send back a RIM reference signal carrying the aggressor set ID. The RIM reference signal sent by the aggressor is able to provide information whether the atmospheric ducting phenomenon exists. The victim gNBs realize the atmospheric ducting phenomenon have ceased upon not receiving any reference signal sent from aggressors.

In the RIM backhaul framework, upon reception of the RIM reference signal from the victim set, aggressor gNBs undertake RIM measures, and establish backhaul coordination towards the victim gNB set. The backhaul messages are sent from individual aggressor gNBs to individual victim gNB, where the signaling is transparent to the core network. The RIM backhaul messages from aggressor to victim gNBs carry the indication about the detection or disappearance of RIM reference signal. Based on the indication from the backhaul message, the victim gNBs realize whether the atmospheric ducting and the consequent remote interference have ceased.

In both frameworks, upon realizing that the atmospheric ducting has disappeared, the victim gNBs stop transmitting the RIM reference signal.

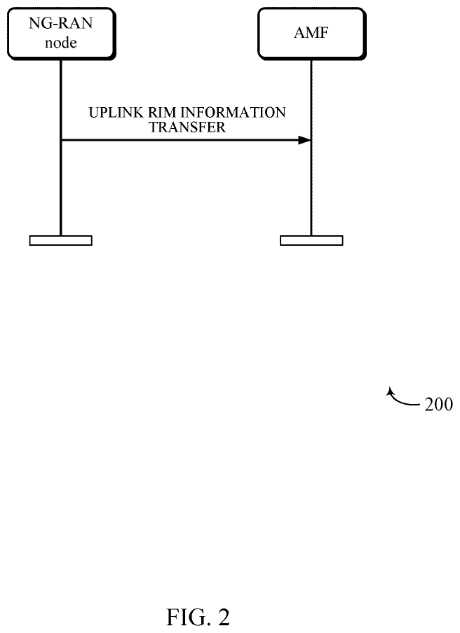

FIG. 2 illustrates a procedure 200 for uplink RIM information transfer. For instance, Uplink RIM Information Transfer procedure 200 enables transfer of RIM information from the NG-RAN node to the AMF. In certain scenarios the AMF does not interpret the transferred RIM information. Further, the procedure 200 can use non-UE associated signaling. Upon reception of the UPLINK RIM INFORMATION TRANSFER message, the AMF may transparently transfer it towards the NG-RAN node indicated in the Target RAN Node ID IE.

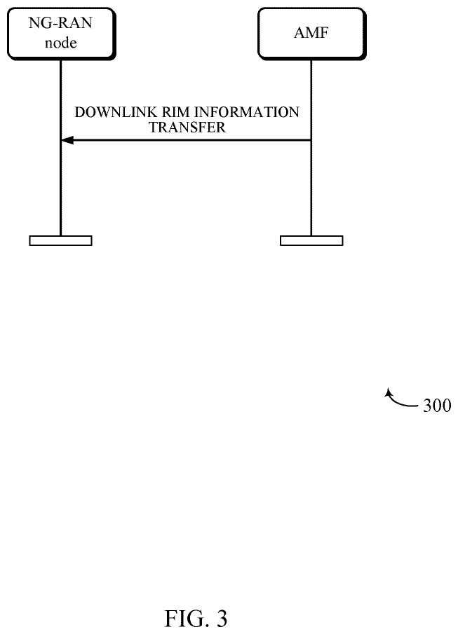

FIG. 3 illustrates a procedure 300 for downlink RIM information transfer. For instance, Downlink RIM Information Transfer procedure 300 enables transfer of RIM information from the AMF to the NG-RAN node. Further, the procedure 300 can use non-UE associated signaling. The AMF can initiate the procedure 300 by sending a DOWNLINK RIM INFORMATION TRANSFER message to the NG-RAN node. The NG-RAN node may use the RIM information in the received DOWNLINK RIM INFORMATION TRANSFER message for executing the RIM functionality, such as specified in Technical Specification (TS) 38.300.

For uplink RIM information transfer, the Message 1 below can be sent by the NG-RAN node to the AMF to transfer the RIM Information, with the direction: NG-RAN→AMF.

Message 1

| | | | | | | |
|---|---|---|---|---|---|---|
| | | | IE type and | Semantics | | Assigned |
| IE/Group Name | Presence | Range | reference | description | Criticality | Criticality |

| | | | | |
|---|---|---|---|---|
| Message Type | M | 9.3.1.1 | YES | ignore |
| RIM Information | O | 9.3.3.28 | YES | ignore |
| Transfer | | | | |

For downlink RIM information transfer, Message 2 below can be sent by the AMF to the NG-RAN node to transfer the RIM information, with the direction: AMF→NG-RAN.

Message 2

| | | | | | | |
|---|---|---|---|---|---|---|
| | | | IE type and | Semantics | | Assigned |
| IE/Group Name | Presence | Range | reference | description | Criticality | Criticality |

| | | | | |
|---|---|---|---|---|
| Message Type | M | 9.3.1.1 | YES | ignore |
| RIM Information | O | 9.3.3.28 | YES | ignore |
| Transfer | | | | |

For RIM information transfer, the IE 1 contains information used by the RIM functionality, and additionally includes the NG-RAN node identifier of the destination of the RIM information and the NG-RAN node identifier of the source of this information.

Information Element 1

| | | | | |
|---|---|---|---|---|
| | | | IE type and | |
| IE/Group Name | Presence | Range | reference | Semantics description |

| | | |
|---|---|---|
| Target RAN Node ID | M | |
| >Global RAN Node ID | M | 9.3.1.5 |
| >Selected TAI | M | TAI |
| | | 9.3.3.11 |
| Source RAN Node ID | M | |
| >Global RAN Node ID | M | 9.3.1.5 |
| >Selected TAI | M | TAI |
| | | 9.3.3.11 |
| RIM Information | M | 9.3.3.29 |

For RIM information, the IE 2 includes RAIM/information.

Information Element 2

| | | | | |
|---|---|---|---|---|
| | | | IE type and | |
| IE/Group Name | Presence | Range | reference | Semantics description |

| | | | |
|---|---|---|---|
| Target gNB Set ID | M | gNB Set ID | The victim gNB Set ID. |
| | | 9.3.1.122 | |
| RIM-RS Detection | M | ENUMERATED | |
| | | (RS detected, RS | |
| | | disappeared, . . . ) | |

A gNB set ID IE 3 can be used to identify a group of gNBs that transmit the same RIM-RS.

| | | | | |
|---|---|---|---|---|
| | | | IE type and | |
| IE/Group Name | Presence | Range | reference | Semantics description |

| | | |
|---|---|---|
| gNB Set ID | M | BIT STRING |
| | | (SIZE(22)) |

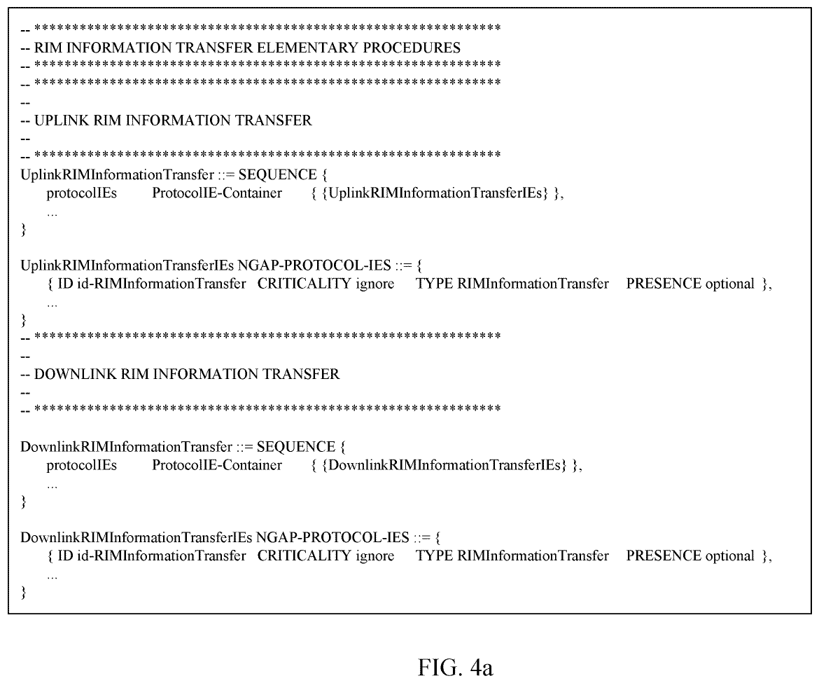

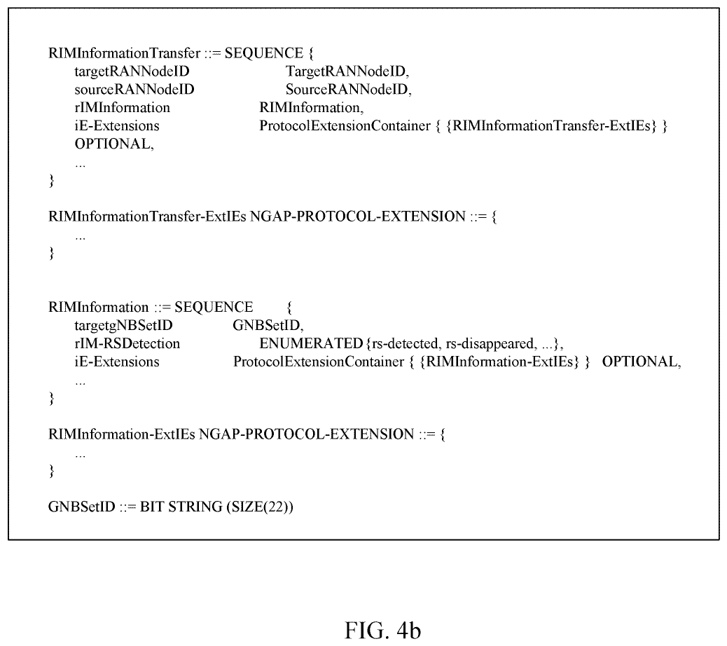

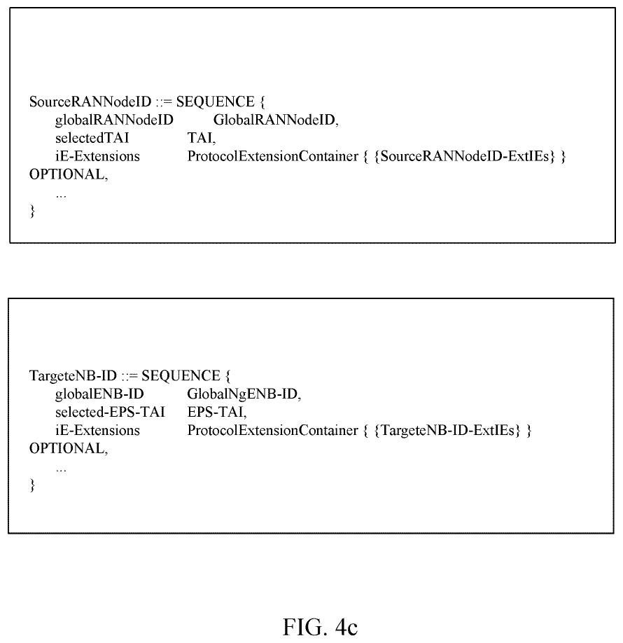

FIGS. 4a, 4b, and 4c illustrate different examples of IEs. The IEs, for instance, include Abstract Syntax Notation One (ASN.1) code for RIM information transfer.

When different TDD DL/UL patterns are used between neighboring cells, UL transmission in one cell may interfere with DL reception in another cell: this is referred to as CLI. To mitigate CLI, gNBs can exchange and coordinate their intended TDD DL-UL configurations over Xn and F1 interfaces; and the victim UEs can be configured to perform CLI measurements. There can be two types of CLI measurements:
Sounding Reference Signal (SRS)-Reference Signal Received Power (RSRP) measurement in which the UE measures SRS-RSRP over SRS resources of aggressor UE(s);
CLI-Receive Signal Strength Indicator (RSSI) measurement in which the UE measures the total received power observed over RSSI resources.

Layer 3 filtering applies to CLI measurement results and both event triggered and periodic reporting are supported.

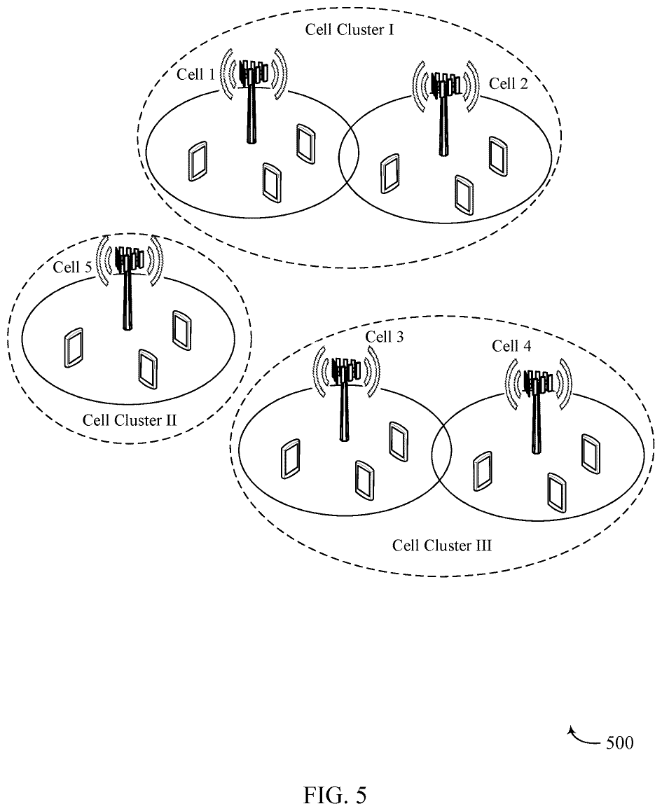

FIG. 5 illustrates a scenario 500 for cell clustering. Interference management can be implemented for mitigating cell clustering interference. For instance, Cell Clustering IM (CCIM) can be implemented, which divides cells into cell clusters according to some metric(s), such as coupling loss, interference level, etc. between cells. A cell cluster can include one or more cells. Active transmissions of cells in each cell cluster can be either uplink or downlink in any subframe or a subset of all subframes, so that eNB-to-eNB interference and UE-to-UE interference can be mitigated within the cell cluster. Hence, coordination between the multiple cells belonging to the same cell cluster can be implemented. Transmission directions in cells belonging to different cell clusters can be different in a subframe by selecting the different TDD configurations freely, in order to achieve the benefits of TDD UL-DL reconfiguration based on traffic adaptation. By forming the cell clusters, eNB-to-eNB and UE-to-UE interference between cells in different cell clusters can be controlled.

Scheme 2: Scheduling dependent interference mitigation This interference mitigation (IM) scheme is named Scheduling Dependent IM (SDIM), where the eNB adjusts the scheduling strategies e.g. link adaptation, resource allocation, transmit power, transmission direction of a subframe, considering e.g. the DL and UL channel quality, the eNB-to-eNB and UE-to-UE interference, traffic load, etc. The adjustment of scheduling strategies can be based on the variation of the observed interference, the estimation of induced interference, inter-cell interference coordination information exchange, and/or cell load.

Scheme 3: Interference mitigation based on eICIC/FeICIC schemes: With different TDD UL-DL configurations in different cells, there are potential interferences from eNB-to-eNB and/or UE-to-UE due to the different transmission directions in adjacent cells. For Rel-10/11 eICIC/FeICIC, extensive specification work has been made to cope with the interference conditions caused in the HetNet deployment, where the interference condition is caused by the strong transmit signal from nearby cells. Although the causes of these interference conditions are different, it can be considered to reuse the interference mitigation schemes and procedures from eICIC/FeICIC to TDD UL-DL reconfiguration based on traffic adaptation, e.g., almost blank subframes, restricted RLM/RRM measurements, dual CSI measurement reports, etc.

Interference suppressing interference mitigation (ISIM) may be considered for UL transmission of either Pico or Macro cells. Suppression of one or more of the dominant eNB-to-eNB interfering signals may be possible, e.g. by enhanced receiver such as Minimum Mean Square Error (MMSE)-Interference Rejection Combining (IRC), or by joint transceiver technologies such as interference alignment or interference nulling.

Scheme 4: Interference suppressing interference mitigation: ISIM may be considered for UL transmission of either Pico or Macro cells. Suppression of one or more of the dominant eNB-to-eNB interfering signals may be possible, e.g. by enhanced receiver such as MMSE-IRC, or by joint transceiver technologies such as interference alignment or interference nulling.

Accordingly, solutions are provided in this disclosure for implementing resource-based clustering and supporting signaling.

In implementations, a plurality of gNBs and/or cells operating in a frequency band may be grouped in one or multiple clusters. Each cluster may be further associated with time and/or frequency resources. As one example, a cluster identified by a cluster ID in a frequency band or carrier may be associated with a plurality of time slots. Further, TDD configurations may match among gNBs and/or cells in the cluster on the time slots. For instance, the gNBs and/or cells can configure a symbol as DL in the gNBs and/or cells in the cluster on the time slots and/or as UL in all the gNBs and/or cells in the cluster on the time slots.

In implementations, a cluster identified by a cluster ID in a frequency band or carrier may be associated with a plurality of PRBs, RBGs, etc. Further, TDD configurations may match among gNBs and/or cells in the cluster when applied to communications on the PRBs/RBGs, e.g., the gNBs and/or cells can configure a symbol as DL in the gNBs and/or cells in the cluster for communications performed on the PRBs/RBGs and/or as UL in all the gNBs and/or cells in the cluster for communications performed on the PRBs/RBGs.

In further implementations, combinations of the above may be applied, e.g., a cluster identified by a cluster ID in a frequency band and/or carrier may be associated with a plurality of time slots as well as a plurality of PRBs, RBGs, etc. Further, TDD configurations may match among gNBs and/or cells in the cluster on the time slots when applied to communications on the PRBs/RBGs. For instance, the gNBs and/or cells can configure a symbol as DL in the gNBs and/or cells in the cluster for communications performed on the PRBs/RBGs on the time slots and/or as UL in all the gNBs and/or cells in the cluster for communications performed on the PRBs/RBGs on the time slots.

In implementations, association of a gNB and/or cell cluster to time and/or frequency resources allows a dynamic clustering among gNBs and/or cells that may not otherwise be divided into non-overlapping clusters. This technique is particularly useful at higher frequencies such as FR2 bands where analog beamforming of base stations towards UEs impacts interference to nearby cells.

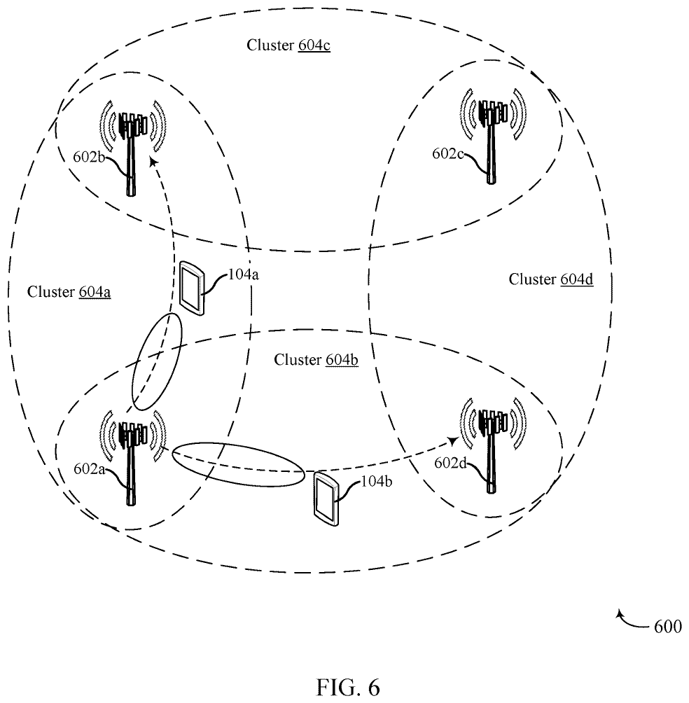

FIG. 6 illustrates a system 600 that supports interference management in accordance with aspects of the present disclosure. In the system 600, 4 base stations (e.g., gNBs) and/or cells are clustered in different clusters, each cluster associated with a plurality of resources. For instance:
Base station 602a is in cluster 604a and cluster 604b
Base station 602b is in cluster 604a and cluster 604c
Base station 602c is in cluster 604c and cluster 604d
Base station 602d is in cluster 604b and cluster 604d

In at least one implementation of the system 600, a UE 104a is served by base station 602a within the cluster 604a and a UE 104b is served by base station 602a within the cluster 604b. However, serving mobile UEs can dynamic according to UE mobility, traffic variations, etc. Further, scheduling individual UEs can be a matter of implementation by individual vendors and/or operators.

In implementations, a gNB and/or cell may not be a member of more than one cluster on a resource such as a time slot and/or a Physical Resource Block (PRB). Examples are as follows:

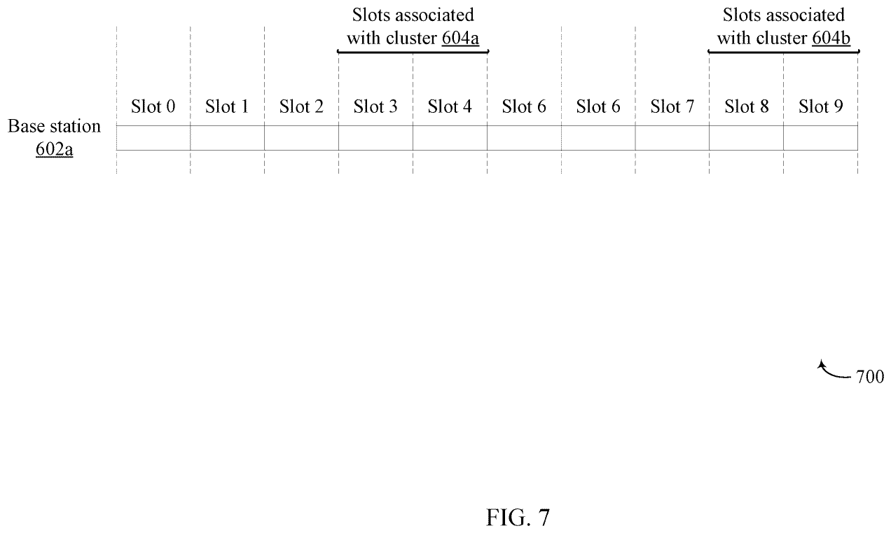

FIG. 7 illustrates a scenario 700 for slot-based clustering that supports interference management in accordance with aspects of the present disclosure. The scenario 700, for example, illustrates example slot configuration for the system 600. In implementations, a gNB and/or cell may not be a member of more than one cluster on a time slot. In the scenario 700, the base station 602a is a member of cluster 604a associated with slots 3 and 4, and a member of cluster 604b associated with slots 8 and 9. The two sets of slots {3, 4} and {8, 9} are non-overlapping as the base station 602a may expect.

In an example, resources such as slots associated with a cluster may include multiple elements, for example whether certain slots are included or excluded in multiple periodicities. In one example, slots 3 and 4 in every periodicity of 10 slots can be associated with a cluster, except every 6 periodicities (e.g., 60 slots). The exception, as an additional element in the pattern of associated resources, may be due to use of the resources for certain signals and/or channels such as SSB, CSI-RS, PRACH, etc., that may impose other constraints such as spatial (e.g., beamforming) constraints. By indicating the exception as an additional pattern element, the gNB and/or cell may be able to use the resources (e.g., in every 60 slots in the example) for those signals and/or channels.

As yet another example, slots 3 and 4 in every periodicity of 10 slots can be associated with the cluster, in addition to slot 2 every 6 periodicities (e.g., 60 slots). In this example, the gNB and/or cell may secure a particular signal and/or channel on slot 2 from exposure to excessive CLI from other gNBs and/or cells in the vicinity.

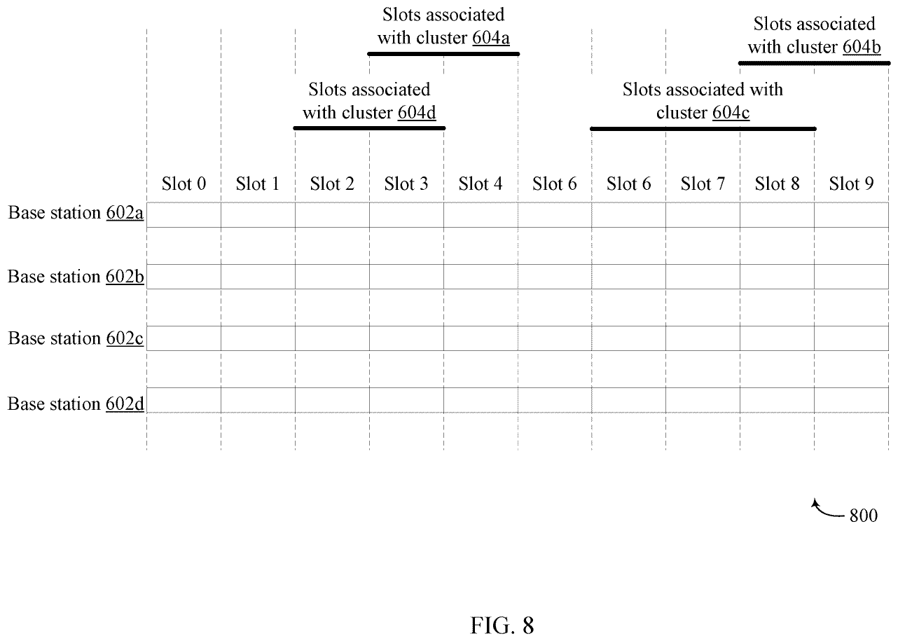

FIG. 8 illustrates a scenario 800 for slot-based clustering that supports interference management in accordance with aspects of the present disclosure. The scenario 800, for example, illustrates example slot configuration for the system 600. In implementations, other clusters may be associated with other sets of time slots. For instance, in the scenario 800, cluster 604a is associated with slots {3, 4}, cluster 604b is associated with slots {8, 9}, cluster 604c is associated with slots {6, 7, 8}, and cluster 604d is associated with slots {2, 3}. Since clusters 604a and 604d are associated with overlapping slots, a gNB and/or cell may not expect to be a member of both clusters 604a and 604d. Similarly, a gNB and/or cell may not expect to be a member of both clusters 604b and 604c. However, other combinations are possible in this example. For instance, base station 602b is a member of clusters 604a and 604c. Accordingly, TDD configuration at base station 602b may be matched with base station 602a on slots {3, 4} and matched with base station 602c on slots {6, 7, 8}.

In implementations, a gNB and/or cell may be a member of, or may be requested to join, two or more clusters associated with overlapping resources. Different behaviors may be defined for the gNB and/or cell. For instance, the gNB and/or cell may reject to join a cluster if the gNB and/or cell determines that the new cluster is associated with resources that overlap with resources with which another cluster the gNB and/or cell is a member of is associated. For example, base station 602a in the aforementioned example may reject to join cluster 604d as it is associated with slots {2, 3} overlapping with slots {3, 4} with which cluster 604a is associated.

In another example, the gNB and/or cell may join the cluster, but apply a TDD matching constraint on resources that do not overlap with resources with which other cluster(s) are associated. For example, base station 602a in the aforementioned example may join cluster 604d, and match TDD configuration with base station 602c and base station 602d only on slot 2, as its TDD configuration is already matched with base station 602b on slot 3.

In another example, the gNB and/or cell may join the cluster and refrain from communicating on resources that impose conflicting DL/UL configurations according to multiple clusters. For example, base station 602a in the aforementioned example may join cluster 604d and then refrain from communicating on any symbols of slot 3 that imposes conflicting DL/UL configurations with base station 602b (according to cluster 604a) versus base stations 602c, 602d, e.g., according to cluster 604d.

In implementations, certain signals and/or channels may be an exception, e.g., the gNB and/or cell may communicate on the resources configured for or allocated to the signals and/or channels even if the communication's DL/UL direction does not match that of a cluster, other gNBs and/or cells in the cluster, a new cluster, other gNBs and/or cells in the new cluster, etc. For example, SSB, periodic CSI-RS, PRACH, Physical Downlink Control Channel (PDCCH)/Control Resource Set (CORESET), SPS, CG-PUSCH, and/or other communication considered high-priority and/or semi-statically configured may be communicated, permanently or temporarily until the associated configuration is updated, even if it has a conflict with a DL/UL constraint. The configuration update of the signals and/or channels may aim at avoiding conflicts with the TDD constraints of the cluster, for example by either or both of:
allocating other resources to a DL signal/channel (SSB, CSI-RS, PDCCH/CORESET, SPS, etc.) if the DL signal/channel is configured on a UL symbol/slot/resource according to the TDD constraints of the cluster;
allocating other resources to a UL signal/channel (PRACH, CG-PUSCH, etc.) if the UL signal/channel is configured on a DL symbol/slot/resource according to the TDD constraints of the cluster.

The examples presented above are described for slot-based clustering. The disclosed techniques may also be employed for clustering in association with other time resources, e.g., OFDM symbols, a time interval described in milliseconds (ms), or a combination. Furthermore, the disclosed techniques and/or variations thereof may be employed for clustering in association with resources in the frequency domain, e.g., a plurality of PRBs or RBGs. For instance, similar rules and behaviors may be applied for scenarios with multiple clusters when their associated resources overlap in the frequency domain.

In implementations, the techniques may be extended to a combination of time and frequency resources, e.g., when a cluster is associated with one or multiple intervals described in slots, symbols, ms, etc., and a plurality of PRBs, RBGs, etc. For instance, similar rules and behaviors may be applied for scenarios with multiple clusters when their associated resources overlap in either or both time and frequency domains.

According to implementations discussed in this disclosure, a slot or OFDM symbol may be associated with a subcarrier spacing or a similar OFDM numerology parameter implicitly or explicitly configured or indicated by a signaling.

Implementations also provide for determination of behaviors for resources that are associated with one or multiple clusters. With respect to other resources, several implementations are disclosed.

In implementations, a gNB and/or cell may match a TDD DL/UL configuration on resources not associated with any cluster with at least one of the following:
neighbor gNBs and/or cells indicated through an automatic neighbor relation (ANR) table;
gNBs and/or cells in a vicinity, e.g., determined by their geographical locations and/or distance from the gNB and/or cell;
gNBs and/or cells detected to cause an interference, such as a gNB-to-gNB CLI.

In an example, a gNB and/or cell may not expect to apply a constraint on TDD DL/UL configuration on resources not associated with any cluster. In yet another example, a gNB and/or cell may implement other mechanisms for determining whether to match TDD DL/UL configuration on resources not associated with a cluster.

According to implementations, the described signaling and behaviors may impact and/or be impacted by flexible resources, e.g., flexible slots and/or symbols. For convenience, flexible resources in time and/or frequency domains may be referred to as flexible symbols herein. Further, a resource in time and/or frequency domains may be referred to as a symbol herein.

In implementations, clustering and/or TDD configuration matching may impact configuration of flexible symbols such as described in the following. Upon creating or joining a cluster, a gNB/cell may match its TDD configuration with a another TDD configuration, which is referred to as a reference TDD configuration herein. This reference TDD configuration may be configured/signaled by the OAM, a core network function, a cluster head, or the like. Matching a first TDD configuration with a second (reference) TDD configuration may include matching DL/UL symbols of the first configuration with those of the second configuration. For instance, if a symbol in the second configuration is DL, a corresponding symbol in the first configuration can be changed/updated to DL, and if a symbol in the second configuration is UL, a corresponding symbol in the first configuration can be changed/updated to UL. With respect to flexible symbols, there are several options as follows.

In an example, for matching the first configuration with the second configuration, the second configuration is not expected to include flexible symbols. In another example, if a symbol in the second configuration is flexible, it is interpreted as not imposing a constraint on matching configurations. In this case, the corresponding symbol in first configuration may not be changed/updated. As a result, gNBs belonging to a cluster associated with a plurality of resources may configure non-matching DL/UL symbols at places indicated flexible by a reference TDD configuration. In some examples, such implementations may be used for making exceptions for critical or high-priority signals and channels such as SSB, CSI-RS for mobility or RRM, SRS, PRACH, PDCCH/CORESET, and the like.

In implementations, if a symbol in the second configuration referenced above is flexible, it can be interpreted as imposing a constraint on matching configurations. In this case, the corresponding symbol in the first configuration may be changed/updated to flexible as well. As a result, a gNB matching its TDD configuration may have a flexibility to indicate the flexible symbol as DL or UL by dynamic scheduling, slot format indication (SFI) signaling, and the like. If a first gNB signals the reference configuration to a second gNB such as a new cluster member, it may indicate all DL, UL, and F (flexible) symbols as previously indicated to the first gNB without discrepancy.

In implementations, a combination of the above may be applied. For example, a flexible (F) symbol may be interpreted as imposing a constraint on matching configurations. However, an alternative indication, which may be referred to as null (N) may indicate that no constraints are imposed on corresponding symbols in matching configurations. As a result, the reference TDD configuration may include at least four types of symbols: DL means a matching symbol is to be DL; UL means a matching symbol is to be UL; F means a matching symbol is to be F; and N means no constraint on a matching symbol.

In implementations, if a symbol in the second configuration is flexible, the matching gNB may not change/update the corresponding symbol in its own (first) configuration. However, the gNB may attempt to avoid allocating the corresponding resource to communications as it may be more prone to interference from gNBs in the vicinity. In one example, the gNB may not configure the resource for periodic or semi-static signals/channels. In another example, the gNB may not allocate the resource dynamically. In yet another example, the gNB may avoid, or attempt to avoid, allocation of the corresponding resource altogether. The behavior may be specified by the standard, configured by the network, or determined according to an implementation.

In implementations, upon matching its TDD configuration, the gNB may signal the changed/updated TDD configuration to other entities such as neighbor gNBs, which may include neighbor gNBs that are not members of an associated cluster. This signaling may assist the other gNBs take interference handling measures according to the new configurations.

In various implementations, joining or creating a new cluster may be impacted by configuration of flexible symbols. A gNB may join a cluster upon determining that reference TDD configuration associated with the cluster on the resources associated with the cluster does not impose a conflicting constraint on symbols already configured as DL and/or UL by the gNB. In this case, the gNB may compare its own (first) configuration with the reference (second) configuration associated with the cluster. If the second configuration indicates DL/UL on symbols that are configured F (flexible) by the gNB, or the indicated DL/UL matches the DL/UL already configured by the gNB, the gNB may join the cluster. However, if the reference configuration indicates a DL/UL on a symbol that is not configured F by the gNB and does not match the DL/UL already configured by the gNB, the gNB may decline to join the cluster. In some examples, if the gNB joins a cluster, the gNB may change/update its configuration by matching some F symbols to DL/UL symbols as constrained by the cluster. Alternatively, the gNB may not change/update its configuration, but instead, strive to match the DL/UL configurations by appropriate resource allocation and/or signaling (such as SFI signaling). As yet another alternative, the gNB may strive to match the DL/UL configurations without explicitly joining the cluster.

It should be noted that, when referring to a symbol configured DL/UL by a gNB, the symbol may be configured as DL/UL in the form of a TDD configuration, or alternatively, allocated to a configured signal or channel. For example, if a TDD configuration of the gNB does not indicate DL for a symbol, but the symbol is allocated to a configured DL signal/channel such as an SSB, CSI-RS, or PDCCH/CORESET, the symbol may be considered as configured DL. Similarly, if a TDD configuration of the gNB does not indicate UL for a symbol, but the symbol is allocated to a configured UL signal/channel such as a PRACH, SRS, or PUCCH, the symbol may be considered as configured UL. Then, rules as described above may be similarly applied in reference to the symbols.

Implementations discussed herein also provide signaling for configuring and determining clusters. For instance, clusters can be pre-configured by an OAM. Static/planned parameters such as the locations of gNBs, expected DL/UL traffic load on each gNB, etc. may be considered for pre-configuration of clusters. In some examples, a certain ratio of resources, such as a certain number of slots in a periodicity, may be associated with one or multiple clusters. Different examples include:
In one example, a certain ratio of resources of each gNB may be associated with one or multiple clusters. For example, 3 slots in a periodicity of 10 slots may be associated with one or multiple clusters.
In another example, a certain ratio of resources in each periodicity may be associated with one cluster. For example, each cluster may be associated 2 slots in a periodicity of 10 slots. Then, the number of slots associated with one or multiple clusters for a certain gNB may be determined based on how many clusters the gNB belongs to, whether resources associated with clusters overlap, etc.
In yet another example, a minimum and/or maximum number of resources (slots, symbols, PRBs, etc.) may be associated with a cluster. In some examples, the minimum and/or maximum may be constant. Alternatively, the minimum and/or maximum may be a function of the type of gNBs (macro gNB vs. small-cell gNB), the number of gNBs in the cluster, and so on.

Furthermore, a gNB may be assigned one or multiple clusters IDs and associated resources based on geographical locations, expected mutual interference among gNBs, and so on. In some examples, a gNB may belong to at most a certain maximum number of clusters.

In implementations, clusters can be indicated by signaling with the core network. In an example, a core network function such as an AMF may signal to each gNB one or more cluster IDs to which the gNB belongs. gNBs belonging to a cluster may communicate directly, for example through Xn interfaces, or indirectly, for example through NG interfaces with a core network function, to match TDD DL/UL configurations.

In one example, association of cluster IDs with resources, such as slots and/or PRBs, may be signaled by the core network function. In another example, the association of cluster IDs with resources may be signaled among gNBs on Xn and/or NG interfaces.

In another example, a core network function such as an AMF may signal to each gNB one or more cluster IDs as well as TDD DL/UL configurations on the resources associated with each cluster ID. Each gNB may then determine TDD DL/UL constraints without having to communicate with other gNBs in the cluster.

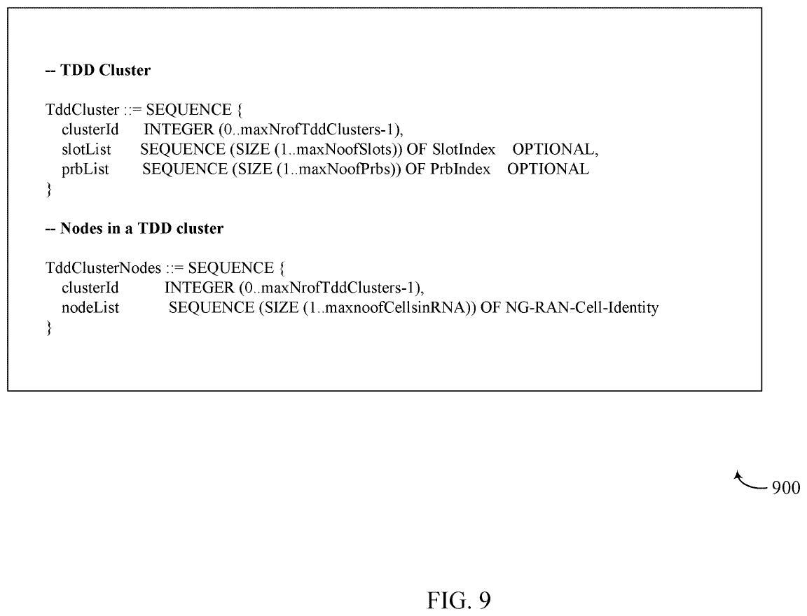

FIG. 9 illustrates at example IE 900 that supports interference management in accordance with aspects of the present disclosure. The IE 900, for instance, includes ASN.1 code for a core network signaling for resource-based gNB clustering. In the IE 900, a first configuration includes a cluster ID and optionally a plurality of associated slots (indicated by the parameter slotList) and/or a plurality of PRBs (indicated by the parameter prbList). Then, a second configuration makes a reference to a cluster by its cluster ID and indicates which gNBs (NG RAN nodes) belong to the cluster. Having obtained information of which gNBs belong to a cluster, a gNB may communicate with other gNBs of the cluster to match TDD DL/UL configurations on the associated slots and/or PRBs.

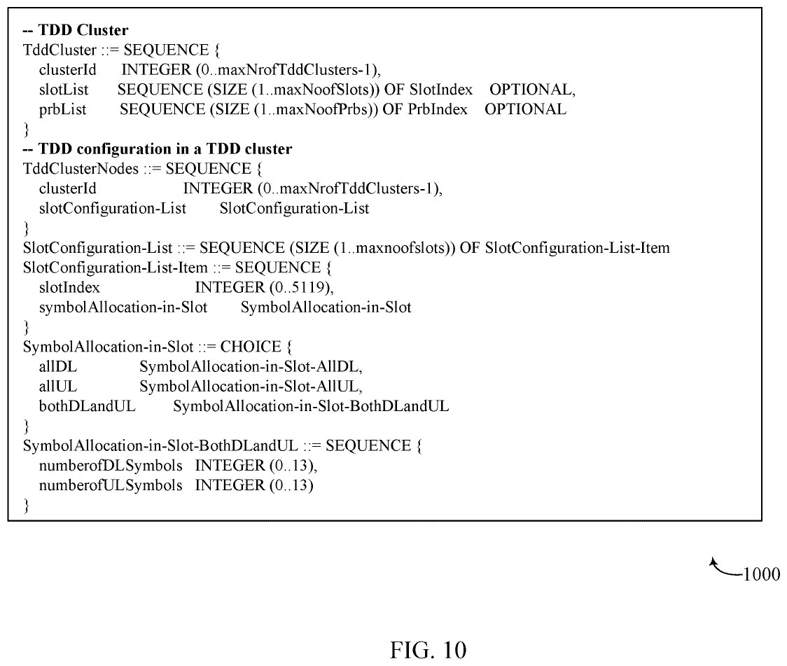

FIG. 10 illustrates at example IE 1000 that supports interference management in accordance with aspects of the present disclosure. The IE 1000, for instance, includes ASN.1 code for core network signaling to indicate TDD DL/UL configurations for associated slots and/or PRBs. In the IE 1000, a gNB configured as a member of cluster N associated with slotList can match TDD DL/UL configurations with the indicated slotConfiguration-List on the slots indicated slotList. In implementations the gNB may not match TDD DL/UL configurations on other slots even if indicated by the core network signaling.

Further, a gNB configured as a member of cluster N associated with prbList may match TDD DL/UL configurations with the indicated slotConfiguration-List on the PRBs indicated prbList. In implementations the gNB may not match TDD DL/UL configurations on other PRBs even if indicated by the core network signaling.

These behaviors can apply to a combination of time and frequency resources as well, e.g., a gNB configured as a member of cluster N associated with slotList and prbList is to match TDD DL/UL configurations with the indicated slotConfiguration-List on the slots and/or PRBs indicated by slotList and/or prbList. In implementations the gNB may not match TDD DL/UL configurations on other slots and/or PRBs even if indicated by the core network signaling.

In implementations, clustering may be performed by signaling among gNBs directly, for example on Xn interfaces, or indirectly, for example on NG interfaces with a core network function. For instance, one gNB is (pre)configured by an OAM or signaled by a core network function as a cluster head. The cluster head may determine resources associated with the cluster, TDD configuration for the associated resources, and so on.

In one example, upon determining the cluster head, a gNB may match TDD DL/UL configurations on the resources associated with the cluster with Intended TDD UL-DL Configuration IE on those resources received from the cluster head. In another example, the cluster head may signal associated resources and the TDD DL/UL configuration for the resources in a separate message/IE.

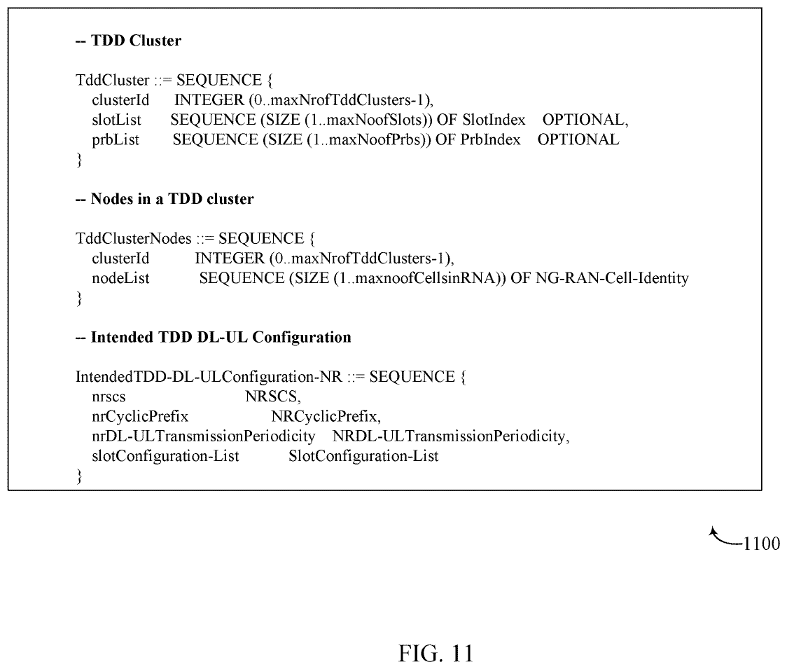

FIG. 11 illustrates at example IE 1100 that supports interference management in accordance with aspects of the present disclosure. The IE 1100, for instance, includes ASN.1 code for inter-gNB configuration/signaling for resource-based gNB clustering. In the IE 1100, a first configuration includes a cluster ID and optionally a plurality of associated slots and/or PRBs. Further, a second configuration makes a reference to a cluster by its cluster ID and indicates which gNBs (e.g., NG RAN nodes) belong to the cluster. Having obtained information of which gNBs belong to a cluster, a gNB configured as a member of cluster N associated with slotList can match TDD DL/UL configurations with the indicated slotConfiguration-List in IntendedTDD-DL-ULConfiguration-NR on slots in indicated by slotList. In implementations the gNB may not match TDD DL/UL configurations on other slots even if indicated by slotConfiguration-List in IntendedTDD-DL-ULConfiguration-NR.

Further, having obtained information of which gNBs belong to a cluster, a gNB configured as a member of cluster N associated with prbList should match TDD DL/UL configurations with the indicated slotConfiguration-List in IntendedTDD-DL-ULConfiguration-NR on the PRBs indicated by prbList. In implementations the gNB may not match TDD DL/UL configurations on other PRBs even if indicated by slotConfiguration-List in IntendedTDD-DL-ULConfiguration-NR.

These behaviors can apply to a combination of time and frequency resources as well, e.g., a gNB configured as a member of cluster N associated with slotList and prbList is to match TDD DL/UL configurations with the indicated slotConfiguration-List in IntendedTDD-DL-ULConfiguration-NR on the indicated slots and/or PRBs indicated by slotList and prbList. In implementations the gNB may not match TDD DL/UL configurations on other slots or PRBs even if indicated by slotConfiguration-List in IntendedTDD-DL-ULConfiguration-NR.

Implementations described herein also provide for clustering that may be performed by signaling among gNBs directly (e.g., on Xn interfaces) or indirectly, for example, on NG interfaces through a core network function. According to implementations, gNBs belonging to a cluster may perform direct signaling for determining TDD DL/UL constraints on the resources associated with the cluster without the presence of a central coordinator such as a core network function or a cluster head.

In an example, a first gNB sends a first message/IE to a second gNB, where the first message/IE indicates a request to form or join a cluster. The message/IE may further include a cluster ID and an associated plurality of resources such as slots and/or PRBs. In response, the second gNB may send a second message/IE to the first gNB indicating whether the second gNB is willing to form or a join the cluster. The message/IE may further include the cluster ID and a parameter indicating whether the associated plurality of resources is accepted by the second gNB.

Alternatively or additionally, instead of the parameter, the second message/IE may include an alternative plurality of resources such as slots and/or PRBs. If different from those included by the first message/IE, the alternative plurality of resources may be interpreted as requested by the second gNB to be associated with the cluster. In an example, the alternative plurality of resources may be a subset of the plurality of resources in the first message/IE. This may indicate to the first gNB that the second gNB may form or join the cluster if associated with not all the plurality of resources indicated by the first gNB in the first message/IE, but instead with the subset of the plurality of resources indicated by the second gNB in the second message/IE. The first message/IE may be called a TDD Cluster Request IE and the second message/IE may be called a TDD Cluster Response IE.

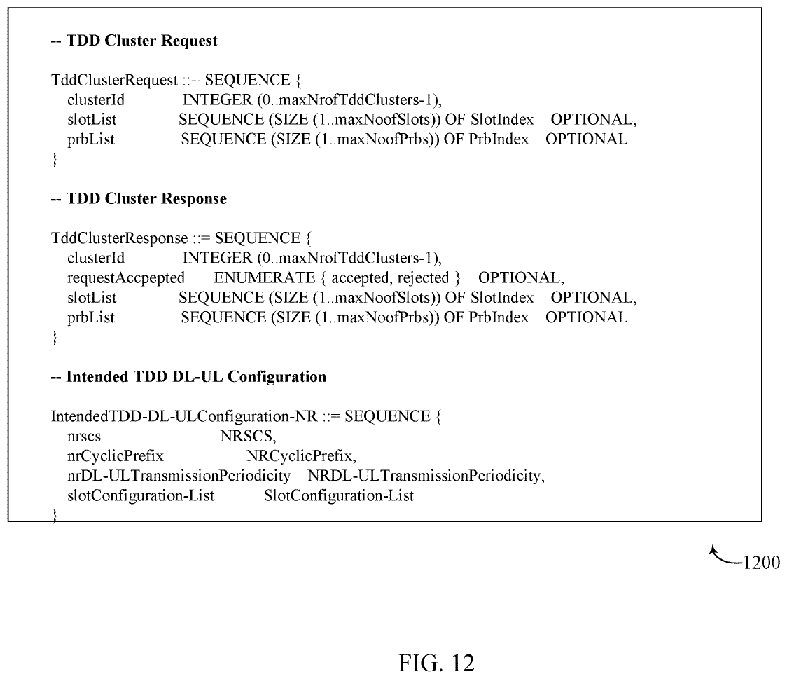

FIG. 12 illustrates at example IE 1200 that supports interference management in accordance with aspects of the present disclosure. The IE 1200, for instance, represents ASN.1 code for inter-gNB configuration/signaling for resource-based gNB clustering.

The IE 1200, for instance, represents two-way handshaking, e.g., when the second gNB sends the TDD Cluster Response, both the first gNB and the second gNB can be assumed members of the indicated cluster. Upon forming a new cluster or joining an existing cluster, the second gNB may match TDD DL/UL configurations of its own with that of the first gNB on the slots and/or PRBs indicated by slotList and prbList of the TDD Cluster Request IE (or the TDD Cluster Response IE if applicable). The TDD DL/UL configuration on the resources may be indicated by slotConfiguration-List in an IntendedTDD-DL-ULConfiguration-NR IE from the first gNB. In implementations the second gNB may not match TDD DL/UL configurations on other slots and/or PRBs even if indicated by the slotConfiguration-List in the IntendedTDD-DL-ULConfiguration-NR IE from the first gNB.

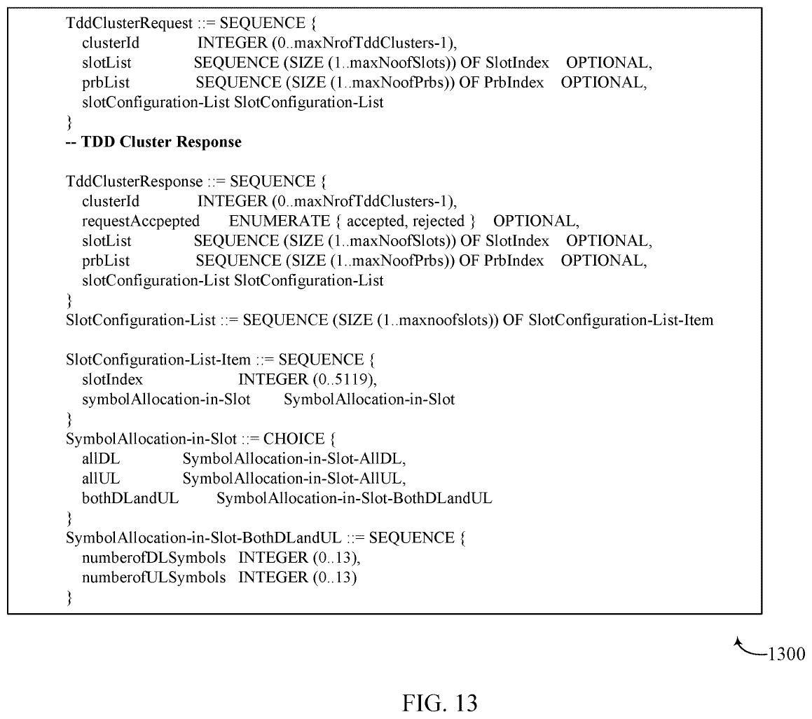

FIG. 13 illustrates an example IE 1300 that supports interference management in accordance with aspects of the present disclosure. The IE 1300, for instance, includes ASN.1 code for a TDD Cluster Request IE and/or a TDD Cluster Response IE with a slot configuration list.

An alternative or addition to the two-way handshaking is a three-way handshaking whereby the first gNB sends a third message/IE indicating that the first gNB accepts association with the alternative plurality of resources indicated by the second gNB in the second message/IE. The third message/IE may be called an TDD Cluster Ack IE. In this case, if the first gNB does not send a TDD Cluster Ack IE, or if the first gNB sends another message/IE such as a TDD Cluster Nack IE, the second gNB may interpret that as the cluster not forming or the second gNB not joining an existing cluster.

In one example, the second gNB may send a TDD Cluster Ack IE if the cluster is not existing. Otherwise, since accepting an alternative plurality of resources may result in inconsistency among gNBs that are already members of the cluster, in implementations the second gNB may not send the TDD Cluster Ack IE or it may send a TDD Cluster Nack IE instead.

In another example, the first gNB may explicitly indicate, in the first message/IE, whether it requests to form a new cluster or requests that the second gNB joins an existing cluster. In the former case, the second gNB may indicate an alternative plurality of resources. However, in the latter case, the second gNB may indicate whether it accepts or rejects to join the cluster.

Implementations also provide for a TDD Cluster Request/Response handshaking to be triggered by a first gNB detecting an excessive interference from a second gNB. In the case of gNB-to-gNB CLI, the first gNB may detect an interference from the second gNB that exceeds a threshold. The interference may be particularly excessive in one or more directions, hence not allowing the first gNB to communicate with UEs in those one or more directions. In this case, the first gNB may send a TDD Cluster Request message to the second gNB such that by matching TDD DL/UL configurations on certain resources, the first gNB may be able to communicate with the UEs on those resources.

In an example, in the case of UE-to-UE CLI, the first gNB may receive a CLI report (e.g., SRS-RSRP or CLI-RSSI) from a UE indicating an interference from a UE served by the second gNB. In this case, the first gNB may send a TDD Cluster Request message to the second gNB such that by matching TDD DL/UL configurations on certain resources, the first gNB may be able to communicate with the UE on those resources. A similar principle may be applicable to centralized methods, such as signaling by the core network or a cluster head, with the difference that the central coordinating entity (core network function or cluster head) may receive CLI reports from other gNBs and/or UEs that trigger a signaling to form a new cluster or add other (possibly interfering) gNBs to an existing cluster.

In implementations, if a base station (gNB) is a member of a cluster (e.g., TDD cluster), the base station may leave the cluster. For instance, in an implementation a gNB may leave a cluster without notice. The gNB may change/update its TDD configuration such that it no longer matches a reference TDD configuration associated with the cluster. This may imply leaving the cluster without notice. No signaling may follow indicating to other gNBs, such as gNBs in the cluster, that the gNB changes/updates its TDD configuration.

In implementations, a gNB may send to other gNBs a message indicating that the gNB is leaving the cluster. The message may include a reference to the cluster, e.g., a cluster ID, and an indication of leaving the cluster. Then, other gNBs, such as neighbor gNBs or other gNBs in the cluster, may infer that there may be new upcoming interference on the resources associated with the cluster.

In implementations, a gNB may signal to other gNBs that it is leaving a cluster by sending a changed/updated TDD configuration that no longer matches a reference TDD associated with the cluster. The changed/updated TDD configuration may include an Intended TDD UL-DL Configuration IE.

In implementations, clusters may be timed and/or scheduled, e.g., a cluster may be created/joined for a certain time interval. In this case, any or all of a TDD cluster request message, TDD cluster response message, cluster configuration message, a TDD configuration associated with the cluster, or the like, may include a parameter that indicates a time interval for validity of the cluster. Accordingly, a gNB creating or joining the cluster may start an expiration timer marking when the cluster expires. Once the cluster expires, its associated TDD constraints on the associated resources may no longer be valid, e.g., the gNBs formerly a member of the cluster may change/update DL/UL configurations of the associated resources or otherwise allocate the resources to signals/channels with arbitrary DL/UL directions.

In implementations, in order to avoid expiration of a cluster, an entity may send a message renewing validity of the cluster. The entity may be a core network function, a cluster head, a member of the cluster, or the like. A gNB receiving the message may reset an associated expiration timer such that cluster expires later.

In implementations, a gNB that is a member of a cluster (that may not be originally timed/scheduled) may receive a message from another entity, such as a core network function or a cluster head, that the cluster is being terminated. Upon receiving the message, the gNB may no longer match its TDD configuration with that of the cluster on the associated resources. Alternatively or additionally, the message may include an indication of a time interval after which the cluster is going to be terminated. Upon receiving the message, the gNB may start an expiration timer associate with the cluster. When the timer expires, the gNB may no longer match its TDD configuration with that of the cluster on the associated resources.

In implementations, if a gNB joins or creates a cluster, the gNB should remain in the cluster for a minimum (and/or maximum) amount of time. The minimum (and/or maximum) may be specified by the standard, configured or signaled by the network, determined by implementation, etc.

Similar to implementations for triggering conditions for creating or joining a cluster, expiration or leaving a cluster by a gNB may be triggered by certain conditions. In various implementations, expiration or leaving a cluster may be triggered by a first gNB that no longer detects an excessive (e.g., threshold) interference from a second gNB.

In the case of gNB-to-gNB CLI, the first gNB may no longer detect an interference from the second gNB that exceeds a threshold. In this case, the first gNB may send to the second gNB a message indicating that the first gNB is leaving the cluster. If the first gNB is a cluster head, it may send a message to member of the cluster that the cluster is terminating. The message may include an expiration period. Alternatively, if the first gNB is not a cluster head, it may send a message to a core network function of a cluster head that it no longer detects a large interference and/or it is requesting to leave the cluster. The first gNB may then leave the cluster wait for a response from the core network function or cluster head approving that the first gNB may leave the cluster. The core network function or the cluster head may consider other factors such as interference reports from other gNBs in the cluster in order to accept the first gNB's request to leave the cluster.

Alternatively or additionally, in the case of UE-to-UE CLI, the first gNB may receive a CLI report (e.g., SRS-RSRP or CLI-RSSI) from a UE indicating that there is no longer an excessive interference from a UE served by the second gNB. In this case, the first gNB may send to the second gNB a message indicating that the first gNB is leaving the cluster. If the first gNB is a cluster head, it may send a message to members of the cluster that the cluster is terminating. The message may include an expiration period. Alternatively or additionally, if the first gNB is not a cluster head, it may send a message to a core network function of a cluster head that it no longer detects a large interference and/or it is requesting to leave the cluster. The first gNB may then leave the cluster wait for a response from the core network function or cluster head approving that the first gNB may leave the cluster.

A similar principle may be applicable to centralized techniques, such as signaling by the core network or a cluster head, with the difference that the central coordinating entity (core network function or cluster head) may receive CLI reports from other gNBs and/or UEs that trigger a signaling to terminate a cluster or allow a gNB to leave the cluster.

In implementations, the terms antenna, panel, and antenna panel are used interchangeably. An antenna panel may be a hardware that is used for transmitting and/or receiving radio signals at frequencies lower than 6 GHz, e.g., frequency range 1 (FR1), or higher than 6 GHz, e.g., frequency range 2 (FR2) or millimeter wave (mmWave). In some implementations, an antenna panel may include an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device (e.g., UE, node) to amplify signals that are transmitted or received from one or multiple spatial directions.

In some implementations, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information may be communicated via signaling or, in some implementations, capability information may be provided to devices without a need for signaling. In the case that such information is available to other devices such as a CU, it can be used for signaling or local decision making.

In some implementations, an antenna panel may be a physical or logical antenna array including a set of antenna elements or antenna ports that share a common or a significant portion of an RF chain (e.g., in-phase/quadrature (I/Q) modulator, analog to digital (A/D) converter, local oscillator, phase shift network). The antenna panel may be a logical entity with physical antennas mapped to the logical entity. The mapping of physical antennas to the logical entity may be up to implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device (e.g., node) associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some implementations, depending on implementation, a “panel” can have at least one of the following functionalities as an operational role of Unit of antenna group to control its Tx beam independently, Unit of antenna group to control its transmission power independently, Unit of antenna group to control its transmission timing independently. The “panel” may be transparent to another node (e.g., next hop neighbor node). For certain condition(s), another node or network entity can assume the mapping between device's physical antennas to the logical entity “panel” may not be changed. For example, the condition may include until the next update or report from device or include a duration of time over which the network entity assumes there will be no change to the mapping. Device may report its capability with respect to the “panel” to the network entity. The device capability may include at least the number of “panels”. In one implementation, the device may support transmission from one beam within a panel; with multiple panels, more than one beam (one beam per panel) may be used for transmission. In another implementation, more than one beam per panel may be supported/used for transmission.

In some of the implementations described, an antenna port is defined such that the channel over which a symbol on the antenna port is conveyed can be inferred from the channel over which another symbol on the same antenna port is conveyed.

Two antenna ports are said to be quasi co-located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the device can assume about their channel statistics or QCL properties. For example, qcl-Type may take one of the following values. Other qcl-Types may be defined based on combination of one or large-scale properties:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation, etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the device may not be able to perform omni-directional transmission, e.g. the device would need to form beams for directional transmission. A QCL-TypeD between two reference signals A and B, the reference signal A is considered to be spatially co-located with reference signal B and the device may assume that the reference signals A and B can be received with the same spatial filter (e.g., with the same receive beamforming weights).

An “antenna port” according to an implementation may be a logical port that may correspond to a beam (resulting from beamforming) or may correspond to a physical antenna on a device. In some implementations, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the implementations described, a TCI-state (Transmission Configuration Indication) associated with a target transmission can indicate parameters for configuring a quasi-collocation relationship between the target transmission (e.g., target RS of Demodulation Reference Signal (DM-RS) ports of the target transmission during a transmission occasion) and a source reference signal(s) (e.g., SSB/CSI-RS/SRS) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell (e.g., between a serving gNB and a smart repeater). In some of the implementations described, a TCI state includes at least one source RS to provide a reference (device assumption) for determining QCL and/or spatial filter.

In some of the implementations described, a UL TCI state is provided if a device is configured with separate DL/UL TCI by RRC signaling. The UL TCI state may include a source reference signal which provides a reference for determining UL spatial domain transmission filter for the UL transmission (e.g., dynamic-grant/configured-grant based PUSCH, dedicated PUCCH resources) in a Component Carrier (CC) or across a set of configured CCs/BWPs.

In some of the implementations described, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated PDCCH/Physical Downlink Shared Channel (PDSCH)) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

In some of the implementations described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

In some of the implementations described, a UL TCI state is provided if a device is configured with separate DL/UL TCI by RRC signaling. The UL TCI state may include a source reference signal which provides a reference for determining UL spatial domain transmission filter for the UL transmission (e.g., dynamic-grant/configured-grant based PUSCH, dedicated PUCCH resources) in a CC or across a set of configured CCs/BWPs.

In some of the implementations described, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated PDCCH/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

The following should be noted throughout the present disclosure and the claimed implementations:

The terms “transmit” and “send” can be used interchangeably and can refer to the communication of data and signaling wirelessly and/or across wired connections.

The different steps described for the example embodiments, in the text and in the flowcharts, may be permuted.

Each configuration may be provided by one or multiple configurations in practice. An earlier configuration may provide a subset of parameters while a later configuration may provide another subset of parameters. Alternatively, a later configuration may override values provided by an earlier configuration or a pre-configuration.

A configuration may be provided by an Xn/NG signaling, RRC signaling, a medium-access control (MAC) signaling, a physical layer signaling such as a downlink control information (DCI) message, a combination thereof, or other methods. A configuration may include a pre-configuration or a semi-static configuration provided by the standard, by the vendor, and/or by the network/operator. Each parameter value received through configuration or indication may override previous values for a similar parameter.

The terms gNB and cell may be used interchangeably in the present disclosure. A gNB may refer to a base station or another network node, such as a next-generation radio access network (NG-RAN) node or a transmission-reception point (TRP). Each network node may provide one or multiple cells. The methods disclosed herein may then apply to a network node, or alternatively, to one or multiple cells provided by the network node.

L1/L2 control signaling may refer to control signaling in layer 1 (physical layer) or layer 2 (data link layer). Particularly, an L1/L2 control signaling may refer to an L1 control signaling such as a DCI message or an Uplink Control Information (UCI) message, an L2 control signaling such as a MAC message, or a combination thereof. A format and an interpretation of an L1/L2 control signaling may be determined by the standard, a configuration, other control signaling, or a combination thereof.

Reference is frequently made, in the present disclosure, to a message or an IE. ‘IE’ is an acronym used frequently in LTE and NR specifications for referring to a configuration at layer 3 and higher. An IE may be included in a message from one layer to another layer or from one entity to another entity. Alternatively, an IE may be included by another IE. In the present disclosure, the terms ‘IE’ and ‘message’ may be used interchangeably when the message includes the IE directly or indirectly.

Any parameter discussed in this disclosure may appear, in practice, as a linear function of that parameter in signaling or specifications.

There is an emphasis in the description of the methods proposed in this disclosure to perform measurements for beam training on reference signals. Alternatively, in some embodiments, a measurement may be performed on resources that are not necessarily configured for reference signals, but rather a node may measure a receive signal power and obtain an RSSI or the like.

In the present disclosure, reference is frequently made to beam indication. In practice, according to a standard specification, a beam indication may refer to an indication of a reference signal by an ID or indicator, a resource associated with a reference signal, a spatial relation information including information of a reference signal or a reciprocal of a reference signal (in the case of beam correspondence).

The terms and acronyms introduced in the present disclosure may be different from those used in future standard specifications. For example, a cluster of base stations or cells may be called a group or a similar term.

Furthermore, several concepts, terms, and acronyms in the present disclosure are used for ease of descriptions and are not meant to limit the scope. In particular, signaling and behaviors proposed according to the present disclosure may be specified in the standard without an explicit mention of clustering or grouping of base stations. For instance, signaling for applying TDD constraints in one or multiple base stations may be (pre-)configured and/or signaled in association with parameters described for clustering/TDD configurations without an explicit mention of clustering or grouping of base stations.

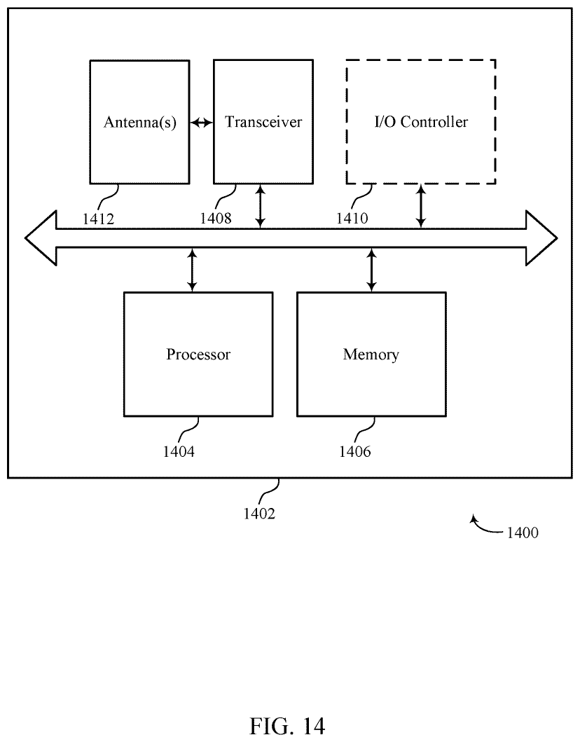

FIG. 14 illustrates an example of a block diagram 1400 of a device 1402 (e.g., an apparatus) that supports interference management in accordance with aspects of the present disclosure. The device 1402 may be an example of a network entity 102 as described herein. The device 1402 may support wireless communication with one or more network entities 102, UEs 104, or any combination thereof. The device 1402 may include components for bi-directional communications including components for transmitting and receiving communications, such as a processor 1404, a memory 1406, a transceiver 1408, and an I/O controller 1410. These components may be in electronic communication or otherwise coupled (e.g., operatively, communicatively, functionally, electronically, electrically) via one or more interfaces (e.g., buses).

The processor 1404, the memory 1406, the transceiver 1408, or various combinations thereof or various components thereof may be examples of means for performing various aspects of the present disclosure as described herein. For example, the processor 1404, the memory 1406, the transceiver 1408, or various combinations or components thereof may support a method for performing one or more of the operations described herein.

In some implementations, the processor 1404, the memory 1406, the transceiver 1408, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1404 and the memory 1406 coupled with the processor 1404 may be configured to perform one or more of the functions described herein (e.g., executing, by the processor 1404, instructions stored in the memory 1406). In the context of network entity 102, for example, the transceiver 1408 and the processor 1404 coupled to the transceiver 1408 are configured to cause the network entity 102 to perform the various described operations and/or combinations thereof.

For example, the processor 1404 and/or the transceiver 1408 may support wireless communication at the device 1402 in accordance with examples as disclosed herein. For instance, the processor 1404 and/or the transceiver 1408 may be configured as or otherwise support a means to obtain a first configuration associating a first apparatus to a group and a plurality of resources; obtain a second configuration of a time-division duplexing (TDD) assignment for the group on the plurality of resources; and apply the TDD assignment for performing communications on the plurality of resources.

Further, in some implementations, to obtain the first configuration, the processor is configured to cause the first apparatus to determine the first configuration from an OAM configuration; to obtain the first configuration, the processor is configured to cause the first apparatus to receive a grouping configuration from a core network function on a backhaul interface; to obtain the first configuration, the processor is configured to cause the first apparatus to receive a grouping configuration from a second base station on a backhaul interface; the second base station includes a central coordinator of the group; the group includes a cluster of a plurality of base stations; the cluster is generated based on an interference level among the plurality of base stations; the cluster is generated based on the interference level measured above a threshold; the plurality of resources includes one or more of a plurality of slots, a plurality of OFDM symbols, or a plurality of physical resource blocks (PRBs); the second configuration assigns a value of one or more of downlink, uplink, or flexible to each resource in the plurality of resources.

Further, in some implementations, to obtain the second configuration, the processor is configured to cause the first apparatus to determine the second configuration from an OAM configuration; to obtain the second configuration, the processor is configured to cause the first apparatus to receive the second configuration from a core network function on a backhaul interface; the first apparatus includes a first base station, and where to obtain the second configuration, the processor is configured to cause the first apparatus to receive the second configuration from a second base station on a backhaul interface; the second base station includes a central coordinator of the group; the processor is configured to cause the first apparatus to not apply an uplink assignment indicated by the second configuration to a subset of the plurality of resources based at least in part on a determination that the subset of the plurality of resources is allocated to a configured downlink signal; the configured downlink signal includes one or more of an SSB, a physical broadcast channel, a periodic channel state information reference signal (CSI-RS), a physical downlink control channel, or SPS.

Further, in some implementations, the processor is configured to cause the first apparatus to not apply a downlink assignment indicated by the second configuration to a subset of the plurality of resources based at least in part on a determination that the subset of the plurality of resources is allocated to a configured uplink signal; the configured uplink signal includes one or more of a PRACH, a PUCCH, or a CG-PUSCH; to apply the TDD assignment, the processor is configured to cause the first apparatus to apply one or more downlink assignments and one or more uplink assignments according to the TDD assignment; the group is created using request-response signaling; to implement at least a portion of the request-response signaling, the processor is configured to cause the first apparatus to: send, to a second apparatus, a TDD cluster request message, the TDD cluster request message including one or more of an indication of a request to create the group, a cluster identifier, or an association with the plurality of resources; and receive, from the second apparatus, a TDD cluster response, the TDD cluster response including an indication that the second apparatus accepts the TDD cluster request.

Further, in some implementations, the first apparatus includes a first base station, and the first base station includes a central coordinator; the processor is configured to cause the first apparatus to detect a threshold amount of interference from the second apparatus and in response, trigger the request-response signaling; the processor is configured to cause the first apparatus to: receive an interference report from a first user equipment (UE), the interference report indicating a threshold amount of interference from a second UE served by the second apparatus; and trigger the request-response signaling based at least in part on the interference report; to implement at least a portion of the request-response signaling, the processor is configured to cause the first apparatus to: receive a TDD cluster request message from a second apparatus, the TDD cluster request message including one or more of an indication of a request to create the group, a cluster identifier, or an association with the plurality of resources; determine whether to accept the TDD cluster request; and send, based at least in part on a determination to accept the request, a TDD cluster response to the second apparatus, the TDD cluster response including an indication that the first apparatus accepts the request; the second apparatus includes a central coordinator; the second configuration includes an intended TDD downlink-uplink configuration IE.

In a further example, the processor 1404 and/or the transceiver 1408 may support wireless communication at the device 1402 in accordance with examples as disclosed herein. The processor 1404 and/or the transceiver 1408, for instance, may be configured as or otherwise support a means to generate at a first apparatus a configuration of a time-division duplexing (TDD) assignment for a group on a plurality of resources; and transmit the configuration to a second apparatus.

Further, in some implementations, the first apparatus includes a first base station, the second apparatus includes a second base station, and the first base station includes a central coordinator of the group; the processor is configured to cause the first apparatus to transmit the configuration to the second apparatus over a backhaul interface

In a further example, the processor 1404 and/or the transceiver 1408 may support wireless communication at the device 1402 in accordance with examples as disclosed herein. The processor 1404 and/or the transceiver 1408, for instance, may be configured as or otherwise support a means to implement, at a first apparatus, at least a portion of request-response signaling to create a group, including to: receive, from a second apparatus, a Time Division Duplex (TDD) cluster request message, the TDD cluster request message including one or more of an indication of a request to create a group, a cluster identifier, or an association with a plurality of resources; and transmit, to the second apparatus, a TDD cluster response, the TDD cluster response including an indication that the first apparatus accepts the TDD cluster request.

Further, in some implementations, the first apparatus includes a first base station, and the first base station includes a central coordinator; the processor is configured to cause the first apparatus to detect a threshold amount of interference from the second apparatus and in response, trigger the request-response signaling; the processor is configured to cause the first apparatus to: receive an interference report from a first user equipment (UE), the interference report indicating a threshold amount of interference from a second UE served by the second apparatus; and trigger the request-response signaling based at least in part on the interference report.

In a further example, the processor 1404 and/or the transceiver 1408 may support wireless communication at the device 1402 in accordance with examples as disclosed herein. The processor 1404 and/or the transceiver 1408, for instance, may be configured as or otherwise support a means to transmit, from a first apparatus to a second apparatus, a Time Division Duplex (TDD) cluster request message, the TDD cluster request message including one or more of an indication of a request to create a group, a cluster identifier, or an association with a plurality of resources; and receive, from the second apparatus, a TDD cluster response, the TDD cluster response including an indication that the second apparatus accepts the TDD cluster request.

Further, in some implementations, the first apparatus includes a first base station, the second apparatus includes a second base station, and the first apparatus includes a central coordinator.

The processor 1404 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1404 may be configured to operate a memory array using a memory controller. In some other implementations, a memory controller may be integrated into the processor 1404. The processor 1404 may be configured to execute computer-readable instructions stored in a memory (e.g., the memory 1406) to cause the device 1402 to perform various functions of the present disclosure.

The memory 1406 may include random access memory (RAM) and read-only memory (ROM). The memory 1406 may store computer-readable, computer-executable code including instructions that, when executed by the processor 1404 cause the device 1402 to perform various functions described herein. The code may be stored in a non-transitory computer-readable medium such as system memory or another type of memory. In some implementations, the code may not be directly executable by the processor 1404 but may cause a computer (e.g., when compiled and executed) to perform functions described herein. In some implementations, the memory 1406 may include, among other things, a basic I/O system (BIOS) which may control basic hardware or software operation such as the interaction with peripheral components or devices.

The I/O controller 1410 may manage input and output signals for the device 1402. The I/O controller 1410 may also manage peripherals not integrated into the device M02. In some implementations, the I/O controller 1410 may represent a physical connection or port to an external peripheral. In some implementations, the I/O controller 1410 may utilize an operating system such as iOS®, ANDROID®, MS-DOS®, MS-WINDOWS®, OS/2®, UNIX®, LINUX®, or another known operating system. In some implementations, the I/O controller 1410 may be implemented as part of a processor, such as the processor M06. In some implementations, a user may interact with the device 1402 via the I/O controller 1410 or via hardware components controlled by the I/O controller 1410.

In some implementations, the device 1402 may include a single antenna 1412. However, in some other implementations, the device 1402 may have more than one antenna 1412 (e.g., multiple antennas), including multiple antenna panels or antenna arrays, which may be capable of concurrently transmitting or receiving multiple wireless transmissions. The transceiver 1408 may communicate bi-directionally, via the one or more antennas 1412, wired, or wireless links as described herein. For example, the transceiver 1408 may represent a wireless transceiver and may communicate bi-directionally with another wireless transceiver. The transceiver 1408 may also include a modem to modulate the packets, to provide the modulated packets to one or more antennas 1412 for transmission, and to demodulate packets received from the one or more antennas 1412.

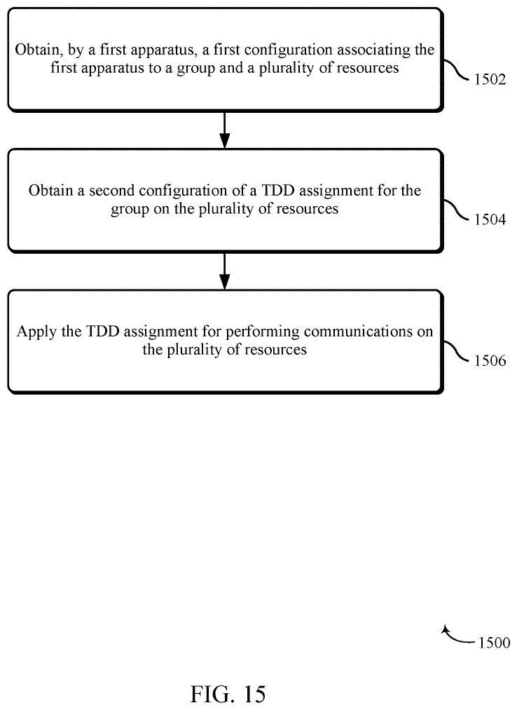

FIG. 15 illustrates a flowchart of a method 1500 that supports interference management in accordance with aspects of the present disclosure. The operations of the method 1500 may be implemented by a device or its components as described herein. For example, the operations of the method 1500 may be performed by a network entity 102 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 1502, the method may include obtaining, by a first apparatus, a first configuration associating the first apparatus to a group and a plurality of resources. The operations of 1502 may be performed in accordance with examples as described herein. In some implementations, aspects of the operations of 1502 may be performed by a device as described with reference to FIG. 1.

At 1504, the method may include obtaining a second configuration of a time-division duplexing (TDD) assignment for the group on the plurality of resources. The operations of 1504 may be performed in accordance with examples as described herein. In some implementations, aspects of the operations of 1504 may be performed by a device as described with reference to FIG. 1.

At 1506, the method may include applying the TDD assignment for performing communications on the plurality of resources. The operations of 1506 may be performed in accordance with examples as described herein. In some implementations, aspects of the operations of 1506 may be performed by a device as described with reference to FIG. 1.

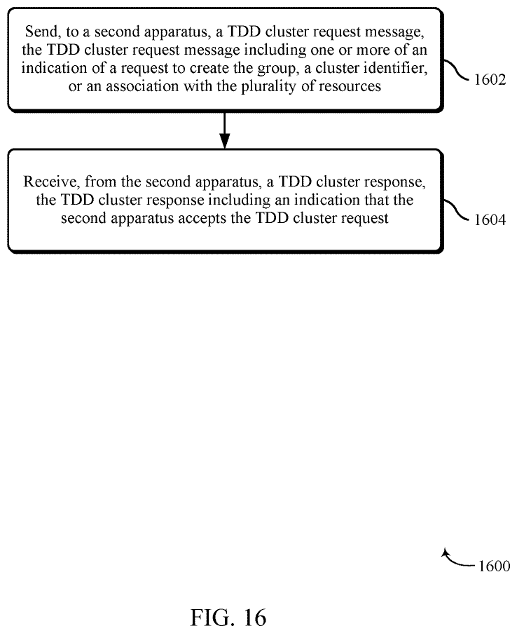

FIG. 16 illustrates a flowchart of a method 1600 that supports interference management in accordance with aspects of the present disclosure. The operations of the method 1600 may be implemented by a device or its components as described herein. For example, the operations of the method 1600 may be performed by a network entity 102 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 1602, the method may include sending, to a second apparatus, a TDD cluster request message, the TDD cluster request message including one or more of an indication of a request to create the group, a cluster identifier, or an association with the plurality of resources. The operations of 1602 may be performed in accordance with examples as described herein. In some implementations, aspects of the operations of 1602 may be performed by a device as described with reference to FIG. 1.

At 1604, the method may include receiving, from the second apparatus, a TDD cluster response, the TDD cluster response including an indication that the second apparatus accepts the TDD cluster request. The operations of 1604 may be performed in accordance with examples as described herein. In some implementations, aspects of the operations of 1604 may be performed by a device as described with reference to FIG. 1.

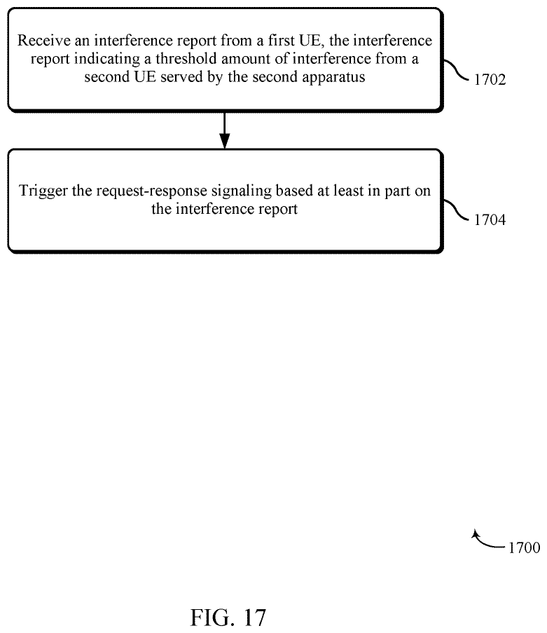

FIG. 17 illustrates a flowchart of a method 1700 that supports interference management in accordance with aspects of the present disclosure. The operations of the method 1700 may be implemented by a device or its components as described herein. For example, the operations of the method 1700 may be performed by a network entity 102 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 1702, the method may include receiving an interference report from a first user equipment (UE), the interference report indicating a threshold amount of interference from a second UE served by the second apparatus. The operations of 1702 may be performed in accordance with examples as described herein. In some implementations, aspects of the operations of 1702 may be performed by a device as described with reference to FIG. 1.

At 1704, the method may include triggering the request-response signaling based at least in part on the interference report. The operations of 1704 may be performed in accordance with examples as described herein. In some implementations, aspects of the operations of 1704 may be performed by a device as described with reference to FIG. 1.

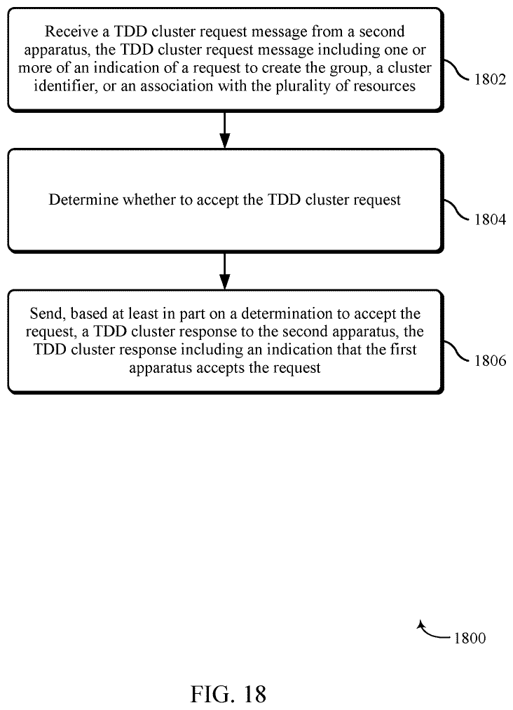

FIG. 18 illustrates a flowchart of a method 1800 that supports interference management in accordance with aspects of the present disclosure. The operations of the method 1800 may be implemented by a device or its components as described herein. For example, the operations of the method 1800 may be performed by a network entity 102 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 1802, the method may include receiving a TDD cluster request message from a second apparatus, the TDD cluster request message including one or more of an indication of a request to create the group, a cluster identifier, or an association with the plurality of resources. The operations of 1802 may be performed in accordance with examples as described herein. In some implementations, aspects of the operations of 1802 may be performed by a device as described with reference to FIG. 1.

At 1804, the method may include determining whether to accept the TDD cluster request. The operations of 1804 may be performed in accordance with examples as described herein. In some implementations, aspects of the operations of 1804 may be performed by a device as described with reference to FIG. 1.

At 1806, the method may include sending, based at least in part on a determination to accept the request, a TDD cluster response to the second apparatus, the TDD cluster response including an indication that the first apparatus accepts the request. The operations of 1806 may be performed in accordance with examples as described herein. In some implementations, aspects of the operations of 1806 may be performed by a device as described with reference to FIG. 1.

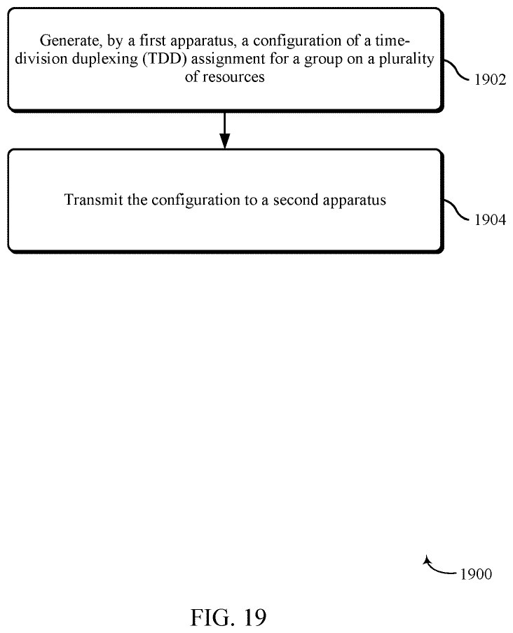

FIG. 19 illustrates a flowchart of a method 1900 that supports interference management in accordance with aspects of the present disclosure. The operations of the method 1900 may be implemented by a device or its components as described herein. For example, the operations of the method 1900 may be performed by a network entity 102 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 1902, the method may include generating, by a first apparatus, a configuration of a time-division duplexing (TDD) assignment for a group on a plurality of resources. The operations of 1902 may be performed in accordance with examples as described herein. In some implementations, aspects of the operations of 1902 may be performed by a device as described with reference to FIG. 1.

At 1904, the method may include transmitting the configuration to a second apparatus. The operations of 1904 may be performed in accordance with examples as described herein. In some implementations, aspects of the operations of 1904 may be performed by a device as described with reference to FIG. 1.

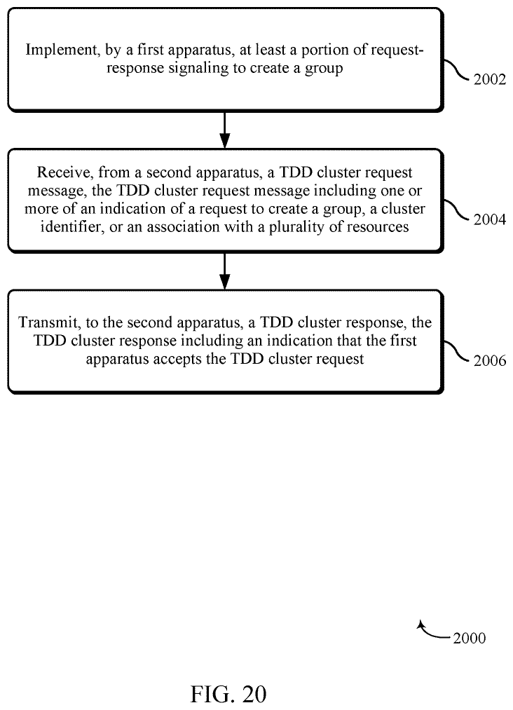

FIG. 20 illustrates a flowchart of a method 2000 that supports interference management in accordance with aspects of the present disclosure. The operations of the method 2000 may be implemented by a device or its components as described herein. For example, the operations of the method 2000 may be performed by a network entity 102 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 2002, the method may include implementing, by a first apparatus, at least a portion of request-response signaling to create a group. The operations of 2002 may be performed in accordance with examples as described herein. In some implementations, aspects of the operations of 2002 may be performed by a device as described with reference to FIG. 1.

At 2004, the method may include receiving, from a second apparatus, a Time Division Duplex (TDD) cluster request message, the TDD cluster request message including one or more of an indication of a request to create a group, a cluster identifier, or an association with a plurality of resources. The operations of 2004 may be performed in accordance with examples as described herein. In some implementations, aspects of the operations of 2004 may be performed by a device as described with reference to FIG. 1.

At 2006, the method may include transmitting, to the second apparatus, a TDD cluster response, the TDD cluster response including an indication that the first apparatus accepts the TDD cluster request. The operations of 2006 may be performed in accordance with examples as described herein. In some implementations, aspects of the operations of 2006 may be performed by a device as described with reference to FIG. 1.

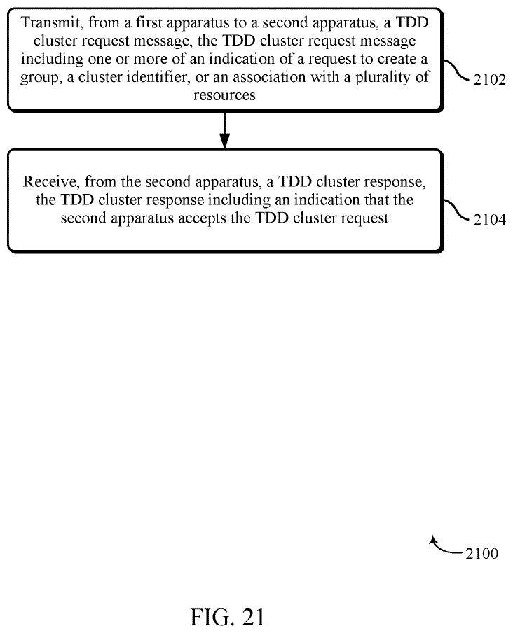

FIG. 21 illustrates a flowchart of a method 2100 that supports interference management in accordance with aspects of the present disclosure. The operations of the method 2100 may be implemented by a device or its components as described herein. For example, the operations of the method 2100 may be performed by a network entity 102 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 2102, the method may include transmitting, from a first apparatus to a second apparatus, a Time Division Duplex (TDD) cluster request message, the TDD cluster request message including one or more of an indication of a request to create a group, a cluster identifier, or an association with a plurality of resources. The operations of 2102 may be performed in accordance with examples as described herein. In some implementations, aspects of the operations of 2102 may be performed by a device as described with reference to FIG. 1.

At 2104, the method may include receiving, from the second apparatus, a TDD cluster response, the TDD cluster response including an indication that the second apparatus accepts the TDD cluster request. The operations of 2104 may be performed in accordance with examples as described herein. In some implementations, aspects of the operations of 2104 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A base station for wireless communication, comprising:
at least one memory; and
at least one processor coupled with the at least one memory and operable to cause the base station to:
obtain, based at least in part on a threshold amount of interference, a first configuration associating the base station to a group and a plurality of resources;
obtain, based at least in part on the threshold amount of interference, a second configuration of a time-division duplexing (TDD) assignment for the group on the plurality of resources; and
apply the TDD assignment for performing communications on the plurality of resources.

2. The base station of claim 1, wherein to obtain the first configuration, the at least one processor is operable to cause the base station to determine the first configuration from an operation, administration, and maintenance (OAM) configuration.

3. The base station of claim 1, wherein to obtain the first configuration, the at least one processor is operable to cause the base station to receive a grouping configuration from a core network function on a backhaul interface.

4. The base station of claim 1, wherein to obtain the first configuration, the at least one processor is operable to cause the base station to receive a grouping configuration from a second base station on a backhaul interface, and wherein the second base station comprises a central coordinator of the group.

5. The base station of claim 1, wherein the group comprises a cluster of a plurality of base stations, the cluster is generated based on an interference level among the plurality of base stations, and the cluster is generated based on the interference level measured above the threshold amount of interference.

6. The base station of claim 1, wherein the plurality of resources comprises one or more of a plurality of slots, a plurality of orthogonal frequency-division multiplexing (OFDM) symbols, or a plurality of physical resource blocks (PRBs).

7. The base station of claim 1, wherein the second configuration assigns a value of one or more of downlink, uplink, or flexible to each resource in the plurality of resources.

8. The base station of claim 1, wherein to obtain the second configuration, the at least one processor is operable to cause the base station to determine the second configuration from an operation, administration, and maintenance (OAM) configuration.

9. The base station of claim 1, wherein to obtain the second configuration, the at least one processor is operable to cause the base station to receive the second configuration from a core network function on a backhaul interface.

10. The base station of claim 1, wherein to obtain the second configuration, the at least one processor is operable to cause the base station to receive the second configuration from a second base station on a backhaul interface, and wherein the second base station comprises a central coordinator of the group.

11. The base station of claim 1, wherein the at least one processor is operable to cause the base station to not apply an uplink assignment indicated by the second configuration to a subset of the plurality of resources based at least in part on a determination that the subset of the plurality of resources is allocated to a configured downlink signal, and wherein the configured downlink signal comprises one or more of a synchronization signal block (SSB), a physical broadcast channel, a periodic channel state information reference signal (CSI-RS), a physical downlink control channel, or a semi-persistent scheduling (SPS).

12. The base station of claim 1, wherein the at least one processor is operable to cause the base station to not apply a downlink assignment indicated by the second configuration to a subset of the plurality of resources based at least in part on a determination that the subset of the plurality of resources is allocated to a configured uplink signal, and wherein the configured uplink signal comprises one or more of a physical random-access channel (PRACH), a physical uplink control channel (PUCCH), or a configured grant physical uplink shared channel (CG-PUSCH).

13. The base station of claim 1, wherein to apply the TDD assignment, the at least one processor is operable to cause the base station to apply one or more downlink assignments and one or more uplink assignments according to the TDD assignment.

14. The base station of claim 1, wherein the group is created using request-response signaling, and wherein to implement at least a portion of the request-response signaling, the at least one processor is operable to cause the base station to:
send, to a second apparatus, a TDD cluster request message, the TDD cluster request message comprising one or more of an indication of a request to create the group, a cluster identifier, or an association with the plurality of resources; and
receive, from the second apparatus, a TDD cluster response, the TDD cluster response comprising an indication that the second apparatus accepts the TDD cluster request.

15. The base station of claim 14, wherein the at least one processor is operable to cause the base station to:
receive an interference report from a first user equipment (UE), the interference report indicating the threshold amount of interference from a second UE served by the second apparatus; and
trigger the request-response signaling based at least in part on the interference report.

16. The base station of claim 14, wherein to implement at least a portion of the request-response signaling, the at least one processor is operable to cause the base station to:
receive a TDD cluster request message from a second apparatus, the TDD cluster request message comprising one or more of an indication of a request to create the group, a cluster identifier, or an association with the plurality of resources;
determine whether to accept the TDD cluster request; and
send, based at least in part on a determination to accept the request, a TDD cluster response to the second apparatus, the TDD cluster response comprising an indication that the base station accepts the request, and wherein the second apparatus comprises a central coordinator.

17. The base station of claim 1, wherein the second configuration comprises an intended TDD downlink-uplink configuration information element (IE).

18. A network entity for wireless communication, comprising:
at least one memory; and
at least one processor coupled with the at least one memory and operable to cause the network entity to:
generate a configuration of a time-division duplexing (TDD) assignment for a group on a plurality of resources; and
transmit the configuration to a second apparatus.

19. A network entity for wireless communication, comprising:
at least one memory; and
at least one processor coupled with the at least one memory and operable to cause the network entity to:
implement at least a portion of request-response signaling to create a group, including to:
receive, from a second apparatus, a Time Division Duplex (TDD) cluster request message, the TDD cluster request message comprising one or more of an indication of a request to create a group, a cluster identifier, or an association with a plurality of resources; and
transmit, to the second apparatus, a TDD cluster response, the TDD cluster response comprising an indication that the network entity accepts the TDD cluster request.

20. A network entity for wireless communication, comprising:
at least one memory; and
at least one processor coupled with the at least one memory and operable to cause the network entity to:
transmit, to a second apparatus, a Time Division Duplex (TDD) cluster request message, the TDD cluster request message comprising one or more of an indication of a request to create a group, a cluster identifier, or an association with a plurality of resources; and
receive, from the second apparatus, a TDD cluster response, the TDD cluster response comprising an indication that the second apparatus accepts the TDD cluster request.
